(19) United States
(12) Patent Application Publication
(10) Pub. No.: US 2010/0053981 A1
(43) Pub. Date: Mar. 4, 2010

(54) Light distribution board having multiple light gratings each with many arciform lenses

(76) Inventor: Pin-Han Chuang, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,568

(22) Filed: Sep. 2, 2008

(51) Int. Cl. F21V 5/04

(52) U.S. Cl. 362/336

(57) ABSTRACT

A light distribution board having multiple light gratings each with many arciform (convex or concave) lenses, the light distribution board is used on a light outputting surface of a lamp shade of an illuminating lamp set, in which at least a transparent board is provided on at least its one surface with a plurality of light gratings, each of these light gratings with many arciform lenses are strip like, annular or arc shaped light gratings in combination and arranged in steps, thus a light distribution board able to provide an effect of uniformly distributing light beams can be formed. With such a structure, light beams can be uniformly distributed and can avoid the phenomenon of Gauss distribution that makes the area below the lamp set especially bright, and can be under control to irradiate a district to be illuminated to get an effect of having wide illumination areas.

### BACKGROUND OF THE INVENTION

1. Field of the Invention

The present invention relates to a light distribution board having multiple light gratings each with many arciform (convex or concave) lenses, and especially to a light distribution board that is designed by using the principles of optical reflection and refraction, it is applicable to various illumination lamp sets, each lamp set can illuminate a district with uniform brightness, tender light beams under the condition of minimum lose of brightness which are non dazzling; the light distribution board is applicable to a place such as a house, an office, a factory or a road requiring illumination, and can achieve an effect of saving energy as well as avoiding the phenomenon of optical pollution.

2. Description of the Prior Art

Illuminating lamp sets generally are divided into two kinds including indoor and outdoor lamp sets; indoor lamp sets mainly are installed each with a half covering type obscured cover 101 (referring to FIG. 1A) having on an inner side thereof a reflective surface 103; the light beams of the lamp set include, in addition to those directly irradiated from the light source, quite a large part of light beams being directly reflected from the reflective surface 103 and out of the lamp set to a district to be illuminated. These lamp sets normally are treated by fogging process on the surface of the light source to avoid irradiating of light to eyes to result a phenomenon of making them feel dazzling and dizzy.

An outdoor lamp set mainly has a fully covering type lamp shade (referring to FIG. 1B) in considering the factor of environment, it is mounted therebeneath with a transparent hood 104, the hood 104 is treated by forming on the surface of a light emitting member many irregularly arranged micro protruding granules (so called as frosted glass) to avoid the phenomenon of dazzling of eyes during looking at the light source directly. The aforesaid two types have a common defect of losing much brightness by treatment by fogging process, these kinds of conventional lamp sets generally have the phenomenon of Gauss distribution that brightness of lamps are concentrated at an area exactly below each lamp set.

Referring to FIG. 2, arciform lenses are divided into two kinds including convex lenses and concave lenses, the drawing shows a phenomenon of refraction that a convex lens can do with incident light beams, several incident light beams 201 enter a convex lens 202 in an identical incident angular direction to result a first time refraction, when the light beams 201 reach a plane surface 203, they are once more refracted toward a district 204 to be illuminated; similarly, several incident light beams 205 enter a convex lens 206 in an identical incident angular direction to result a first time refraction, when the light beams 205 reach the plane surface 203, they are once more refracted toward a district 207 to be illuminated; We can see from the drawing that the incident light beams after being refracted in an identical incident angular direction to the two convex lenses of different curvatures will be refracted in different angular directions, wherein the convex lens 206 of a smaller curvature has a longer focus, the light beams after being refracted from the convex lens 206 cross at the focus, they form a narrower illuminated range at the district 207 to be illuminated in comparison with that resulted from the convex lens 202; the convex lens 202 of a larger curvature has a shorter focus, the light beams after being refracted cross at the focus, they form a wider illuminated range at the district 204 in comparison with that resulted from the convex lens 206. The tilting angles of the two convex lenses are both zero, and the refracted beams of them are all limited within the areas exactly below the convex lenses respectively.

Referring to FIG. 3 which shows a phenomenon of refraction that a concave lens can do with incident light beams, several incident light beams 301 enter a concave lens 302 in an identical incident angular direction to result a first time refraction, when the light beams 301 reach a plane surface 303, they are once more refracted toward a district 304 to be illuminated; similarly, several incident light beams 305 enter a convex lens 306 in an identical incident angular direction to result a first time refraction, when the light beams 305 reach the plane surface 303, they are once more refracted toward a district 307 to be illuminated; We can see from the drawing that the light beams after being refracted from those incident light beams in an identical incident angular direction to the two concave lenses of different curvatures will be refracted in different angular directions, wherein the concave lens 306 of a smaller curvature will render the light beams to spread toward the two lateral sides, they form a narrower illuminated range at the district 307 to be illuminated in comparison with that resulted from the concave lens 302; the concave lens 302 of a larger curvature will also render the light beams to spread toward the two lateral sides, they form a wider illuminated range at the district 304 in comparison with that resulted from the concave lens 306. The tilting angles of the two concave lenses are both zero, and the refracted beams of them are all limited within the areas exactly below the concave lenses respectively.

Referring to FIGS. 4 and 4A which are depicted with another conventional convex lens grating 401 of which the structure is more similar to that of the present invention, and of which a bottom surface 402 is a plane surface, and its top surface has a plurality of strip-like convex lens light gratings 403. Each of these convex lens light gratings 403 is characterized in that its bottom surface 402 is a plane surface, and its top surface has a plurality of strip-like convex lens light gratings 403, the curvatures and the surface areas of all the convex lens light gratings 403 are same and the tilting angles of them are all zero, the conventional convex lens grating 401 is applicable to making materials of 3D pictures, after the bottom surface 402 of the convex lens grating 401 is printed, or stuck with a picture processed by a method enduing with a specific effect, the effect of refraction of such conventional convex lens grating 401 can present a picture with a 3D stereo effect.

Referring to FIGS. 5 and 5A which are depicted with another conventional convex lens grating 501 of which the structure is also more similar to that of the present invention, and of which a bottom surface 502 is a plane surface, and its top surface has a plurality of granular convex lens light gratings 503. Each of these convex lens light gratings 503 is characterized in that its bottom surface 502 is a plane surface, and its top surface has a plurality of convex lenses arranged in a regular array, the curvatures and the surface areas of all the convex lens light gratings 503 are same and the tilting angles of them are all zero, the conventional convex lens grating 501 is applicable to making materials of 3D pictures, after the bottom surface 502 of the convex lens grating 501 is printed, or stuck with a picture processed by a method enduing with a specific effect, the effect of refraction of such conventional convex lens grating 501 can present a picture with a 3D stereo effect.

When the two kinds of granular convex lens light gratings of FIGS. 4 and 5 are used for light distribution of lamp sets, all the light beams will be concentrated to the areas exactly below the lamp sets respectively, under the condition of having short distance of illumination, it is unable to get an effect of having wide illumination areas.

### SUMMARY OF THE INVENTION

In order to get rid of the defects of the conventional lamp sets, the present invention provided a light distribution board having multiple light gratings each with many arciform (convex or concave) lenses arranged in steps, the light distribution board is mounted on a light outputting surface of one of various conventional lamp sets to control the refraction angular directions of most of the light beams of the lamp set, so that the light beams can irradiate a predetermined district to be illuminated to get effects of uniformly distributing and having a wide illumination area. At least a transparent board is provided on its top surface with a plurality of light gratings each with many arciform (convex or concave) lenses arranged in steps; these light gratings each with many arciform (convex or concave) lenses are strip like light gratings; the top surface is a light receiving surface of the lamp set. The bottom surface of the transparent board can be a plane surface, an arc shaped surface or is formed thereon a plurality of granular convex lenses, and the bottom surface is an illuminating surface of the lamp set. With such a structure, light beams can be uniformly distributed and can avoid the phenomenon of Gauss distribution that makes the area below the lamp set especially bright, and can get an effect of having wide illumination areas, except to this, they can avoid the phenomenon of dazzling of eyes during looking at the light emitting member in the lamp set, and the light beams become more tender under the condition that lose of brightness is minimum.

Moreover, the light distribution board provided in the present invention can be formed on a top surface of at least a transparent board a plurality of light gratings each with many arciform (convex or concave) lenses, these light grating each with many arciform lenses are arranged in steps and are annular light gratings; the top surface is a light receiving surface of the lamp set. The bottom surface of the transparent board can be a plane surface, an arc shaped surface or a surface formed thereon a plurality of granular convex lenses, and the bottom surface is an illuminating surface of the lamp set.

Further, the light distribution board provided in the present invention can be formed on a top surface of at least a transparent board each with many arciform (convex or concave) lenses, these light grating each with many arciform lenses are arranged in steps and are arc shaped light gratings; the top surface is a light receiving surface of the lamp set. The bottom surface of the transparent board can be a plane surface an arc shaped surface or a surface formed thereon a plurality of granular convex lenses, and the bottom surface is an illuminating surface of the lamp set.

In a light distribution board provided in the present invention, curvature and tilting angle of each arciform lens of each light grating formed on the top surface are changed in pursuance of the angles of refraction of the incident light beams through the lens surfaces. While curvature and the inter-lens distance between every two granular convex lenses are changed in pursuance of the angles of refraction of the incident light beams through the lens surfaces. Thereby light beams in a lamp set can be refracted toward a small area of the district to be illuminated, thus the light beams can be uniformly distributed and can avoid the phenomenon of Gauss distribution that makes the area below the lamp set especially bright.

The present invention will be apparent in its structure and principle after reading the detailed description of the preferred embodiment thereof in reference to the accompanying drawings.

### BRIEF DESCRIPTION OF THE DRAWINGS

FIG. 1A is a schematic sectional view of a conventional half covering type illumination lamp set;

FIG. 1B is a schematic sectional view of a conventional fully covering type illumination lamp set;

FIG. 2 is a schematic view showing a conventional convex lens grating structure and fraction of light beams;

FIG. 3 is a schematic view showing a conventional concave lens grating structure and fraction of light beams;

FIG. 4 is a side view showing a conventional granular convex lens grating structure;

FIG. 4A is a top view of FIG. 4;

FIG. 5 is a side view showing a conventional strip like convex lens grating structure;

FIG. 5A is a top view of FIG. 5;

FIGS. 6, 6A are views of a first embodiment of light distribution board of the present invention;

FIG. 7 is an enlarged schematic view showing a light distribution board having multiple convex lens light gratings, showing the phenomenon of refraction in using the multiple convex lens light gratings arranged in steps;

FIGS. 8, 8A are views of a second embodiment of light distribution board of the present invention;

FIG. 9 is an enlarged schematic view of a light distribution board having multiple concave lens light gratings, showing the phenomenon of refraction in using the multiple convex lens light gratings arranged in steps;

FIGS. 10, 10A are views of a third embodiment of light distribution board of the present invention;

FIGS. 11, 11A are views of a fourth embodiment of light distribution board of the present invention;

FIGS. 12, 12A are views of a fifth embodiment of light distribution board of the present invention;

FIGS. 13, 13A are views of a sixth embodiment of light distribution board of the present invention;

FIGS. 14, 14A are views of a seventh embodiment of light distribution board of the present invention;

FIGS. 15, 15A are views of a eighth embodiment of light distribution board of the present invention;

FIGS. 16, 16A are views of a ninth embodiment of light distribution board of the present invention;

FIGS. 17, 17A are views of a tenth embodiment of light distribution board of the present invention;

FIGS. 18 and 18A are views of an eleventh embodiment of light distribution board of the present invention;

FIGS. 19, 19A are views of a twelfth embodiment of light distribution board of the present invention;

FIGS. 20, 20A are views of a thirteenth embodiment of light distribution board of the present invention;

FIGS. 21, 21A are views of a fourteenth embodiment of light distribution board of the present invention;

FIGS. 22, 22A are views of a fifteenth embodiment of light distribution board of the present invention;

FIGS. 23, 23A are views of a sixteenth embodiment of light distribution board of the present invention;

FIGS. 24 and 24A are views of a seventeenth embodiment of light distribution board of the present invention;

FIGS. 25 and 25A are views of an eighteenth embodiment of light distribution board of the present invention;

FIGS. 26 and 26A are views of a nineteenth embodiment of light distribution board of the present invention;

FIGS. 27 and 27A are views of a twentieth embodiment of light distribution board of the present invention;

FIGS. 28 and 28A are views of a twenty first embodiment of light distribution board of the present invention;

FIGS. 29 and 29A are views of a twenty second embodiment of light distribution board of the present invention;

FIGS. 30 and 30A are views of a twenty third embodiment of light distribution board of the present invention;

FIGS. 31 and 31A are views of a twenty fourth embodiment of light distribution board of the present invention;

FIGS. 32 and 32A are views of a twenty fifth embodiment of light distribution board of the present invention;

FIGS. 33 and 33A are views of a twenty sixth embodiment of light distribution board of the present invention;

FIGS. 34 and 34A are views of a twenty seventh embodiment of light distribution board of the present invention;

FIGS. 35 and 35A are views of a twenty eighth embodiment of light distribution board of the present invention;

FIGS. 36 and 36A are views of a twenty ninth embodiment of light distribution board of the present invention;

FIGS. 37 and 37A are views of a thirtieth embodiment of light distribution board of the present invention;

FIGS. 38 and 38A are views of a thirty first embodiment of light distribution board of the present invention;

FIGS. 39 and 39A are views of a thirty second embodiment of light distribution board of the present invention;

FIG. 40 is a sectional view showing an embodiment of which at least a side of a transparent board of the present invention is used to form a light distribution board having multiple light gratings each with many arciform (convex or concave) lenses and being used on a lamp set;

FIG. 41 is a sectional view showing another embodiment of which at least a side of a transparent board of the present invention is used to form a light distribution board having multiple light gratings each with many arciform (convex or concave) lenses and being used on a lamp set.

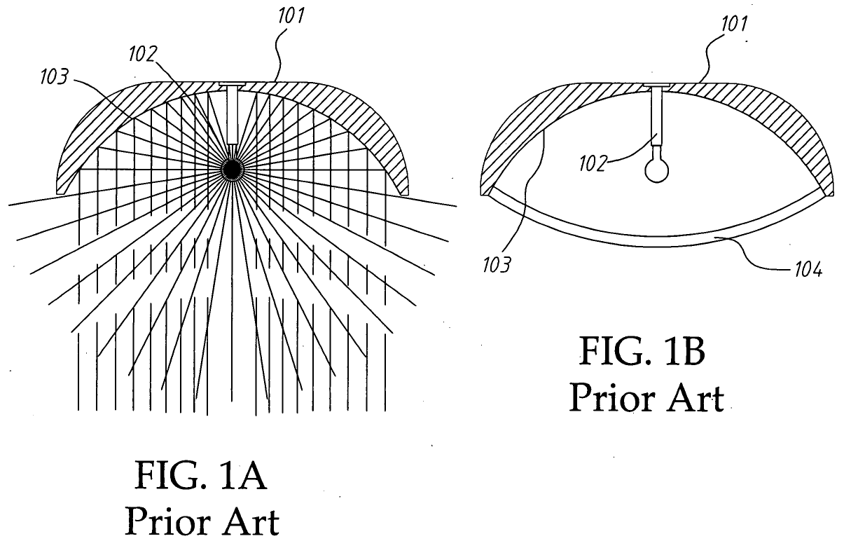

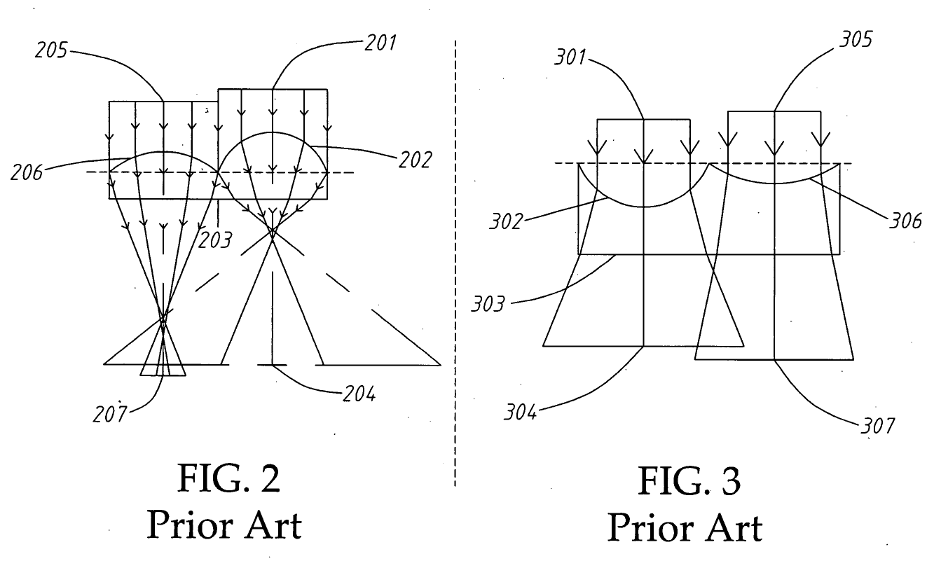

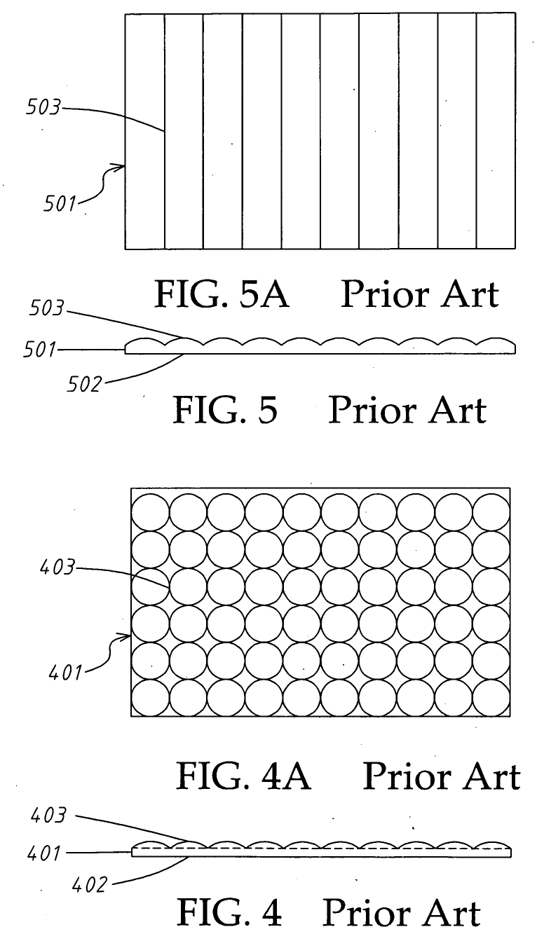

### DETAILED DESCRIPTION OF THE PREFERRED EMBODIMENT

The present invention relates to a light distribution board having multiple light gratings each with many arciform (convex or concave) lenses, in which at least a transparent board is used to form the light distribution board as an illuminating cover for a lamp set. The transparent board can be in a rectangular, round, elliptical or strange shape; the material for the transparent board can be transparent plastics, transparent glass or some other transparent material. The transparent board is formed on at least one side thereof a plurality of light gratings each with many arciform (convex or concave) lenses in combination and arranged in steps, curvature and tilting angle of each light grating with a many arciform (convex or concave) lenses are changed in pursuance of the angles of refraction of the incident light beams through the lens surfaces.

The light distribution board of the present invention is described with many embodiments below:

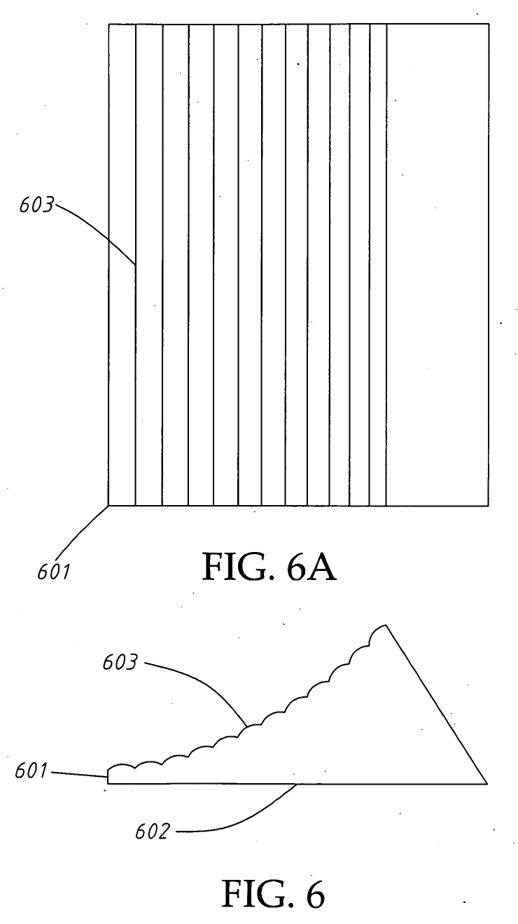

Referring to FIGS. 6 and 6A which are plane views of a first embodiment of light distribution board of the present invention, in the drawings, a bottom surface 602 of a transparent board 601 is a plane surface, and a top surface of the transparent board 601 is formed thereon a plurality of strip like arciform lens light gratings 603 in combination and arranged in steps. The curvature and inclination angle of each convex lens of the strip like light gratings 603 (that are shown as convex lens light gratings in this drawing) of the transparent board 601 are changed in pursuance of the angles of refraction of the incident light beams through the lens surfaces.

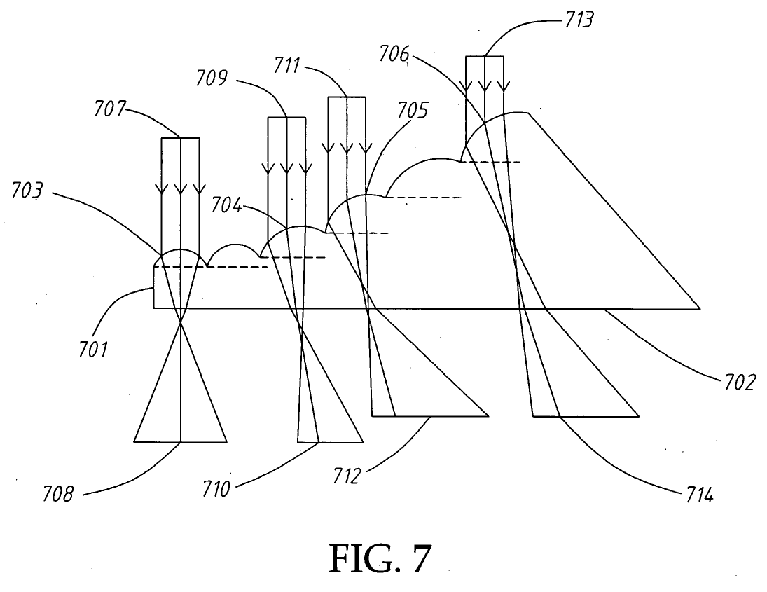

Referring to FIG. 7 which is an enlarged schematic view of FIG. 6, showing the phenomenon of refraction in using the multiple convex lens light gratings of different inclination angles; in the drawings, a bottom surface 702 of a transparent board 701 is a plane surface, and a top surface of the transparent board 701 is formed thereon a plurality of convex lens light gratings 703, 704, 705, 706 . . . in combination and arranged in steps. Several incident light beams 707 enter the convex lens light grating 703 in an identical incident angular direction to result a first time refraction, when the light beams 707 reach the plane surface 702, they are once more refracted toward a district 708 to be illuminated; similarly, several incident light beams 709 enter a convex lens light grating 704 in an identical incident angular direction to result a first time refraction, when the light beams 709 reach the plane surface 702, they are once more refracted toward a district 710 to be illuminated; and several incident light beams 711 enter a convex lens light grating 705 in an identical incident angular direction to result a first time refraction, when the light beams 711 reach the plane surface 702, they are once more refracted toward a district 712 to be illuminated; several incident light beams 713 enter a convex lens light grating 706 in an identical incident angular direction to result a first time refraction, when the light beams 713 reach the plane surface 702, they are once more refracted toward a district 714 to be illuminated; We can see from the drawing that after the convex lens gratings are assembled in combination and arranged in steps with the tilting angles of the convex lens light gratings being larger and larger one than another serially, the incident light beams (such as 707, 709, 711 and 713 depicted) in identical incident angular directions are refracted toward one lateral side with their refraction angles also being larger and larger one than another serially, i.e., the larger the tilting angles of the convex lens light gratings are, the larger the refraction angles of the light beams irradiating toward the lateral side will be.

From the statement above, we can see that so long as the curvature and inclination angle of each convex lens of the multiple convex lens light gratings are under control, the effect of uniformly distributing of light beams at the district to be illuminated and having wide illumination areas can be achieved.

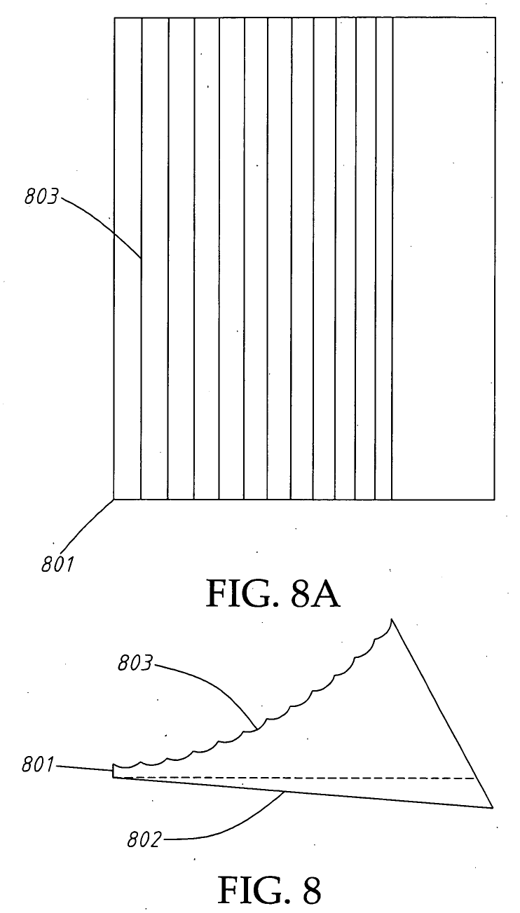

Referring to FIGS. 8 and 8A which are plane views of a second embodiment of light distribution board of the present invention, in the drawings, a bottom surface 802 of a transparent board 801 is a bevel surface, and a top surface of the transparent board 801 is formed thereon a plurality of strip like arciform lens light gratings 803 (that are shown as concave lens light gratings in this drawing) in combination and arranged in steps. The curvature and inclination angle of each concave lens of the strip like arciform lens light gratings 803 of the transparent board 801 are changed in pursuance of the angles of refraction of the incident light beams through the lens surfaces.

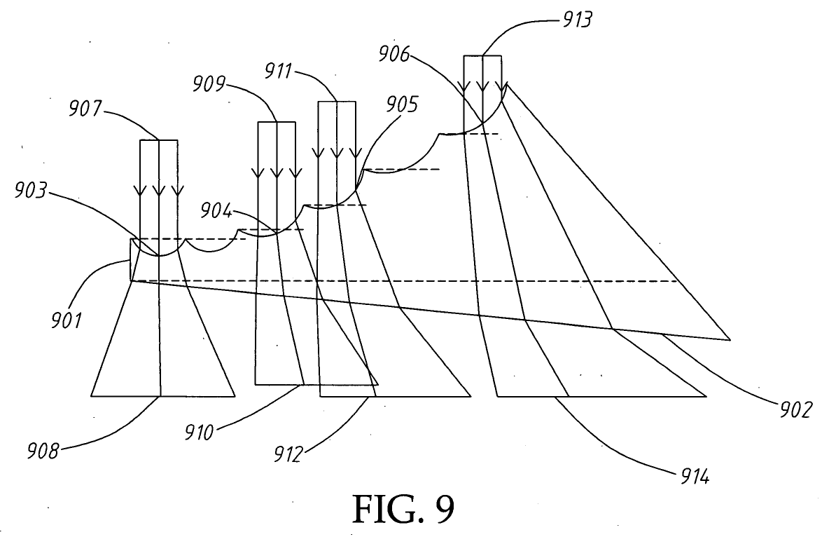

Referring to FIG. 9 which is an enlarged schematic view of FIG. 8, showing the phenomenon of refraction in using the multiple concave lens light gratings of different inclination angles; in the drawings, a bottom surface 902 of a transparent board 901 is a bevel surface, and a top surface of the transparent board 901 is formed thereon a plurality of concave lens light gratings 903, 904, 905, 906 . . . in combination and arranged in steps. Several incident light beams 907 enter the concave lens light grating 903 in an identical incident angular direction to result a first time refraction, when the light beams 907 reach the bevel surface 902, they are once more refracted toward a district 908 to be illuminated; similarly, several incident light beams 909 enter a concave lens light grating 904 in an identical incident angular direction to result a first time refraction, when the light beams 909 reach the plane surface 902, they are once more refracted toward a district 910 to be illuminated; and several incident light beams 911 enter a concave lens light grating 905 in an identical incident angular direction to result a first time refraction, when the light beams 911 reach the plane surface 902, they are once more refracted toward a district 912 to be illuminated; several incident light beams 913 enter a concave lens light grating 906 in an identical incident angular direction to result a first time refraction, when the light beams 913 reach the plane surface 902, they are once more refracted toward a district 914 to be illuminated; We can see from the drawing that after the concave lens gratings are assembled in combination and arranged in steps with the tilting angles of the convex lens light gratings being larger and larger one than another serially, the incident light beams (such as 907, 909, 911 and 913 depicted) in identical incident angular directions are refracted toward one lateral side with their refraction angles also being larger and larger one than another serially, i.e., the larger the tilting angles of the concave lens light gratings are, the larger the refraction angles of the light beams irradiating toward the lateral side will be.

From the statement above, we can see that so long as the curvature and inclination angle of each concave lens of the multiple concave lens light gratings are under control, the effect of uniformly distributing of light beams at the district to be illuminated and having wide illumination areas can be achieved.

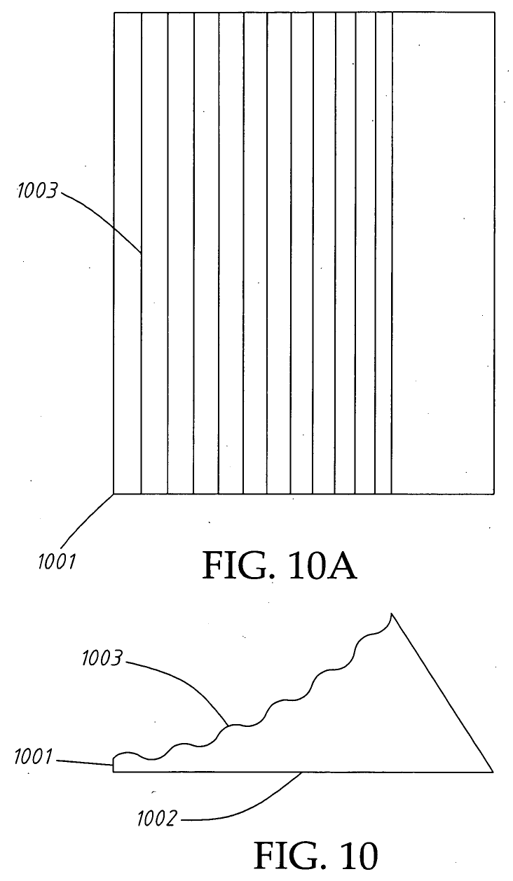

Referring to FIGS. 10 and 10A which are plane views of a third embodiment of light distribution board of the present invention, in the drawings, a bottom surface 1002 of a transparent board 1001 is a plane surface, and a top surface of the transparent board 1001 is formed thereon a plurality of strip like convex and concave lens light gratings 1003 in combination and arranged in steps. The curvature and inclination angle of each of the strip like convex and concave lens light gratings 1003 of the transparent board 1001 are changed in pursuance of the angles of refraction of the incident light beams through the lens surfaces.

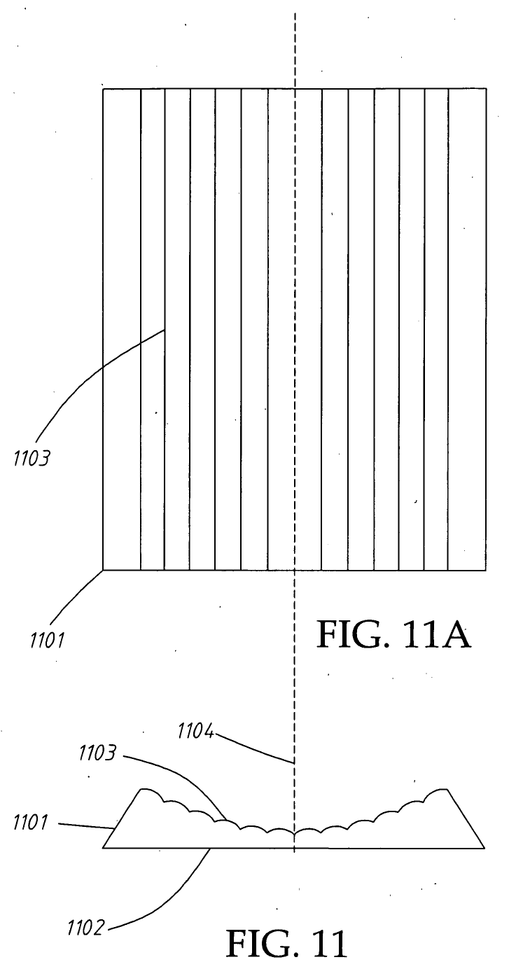

Referring to FIGS. 11 and 11A which are plane views of a fourth embodiment of light distribution board of the present invention, in the drawings, a bottom surface 1102 of a transparent board 1101 is a plane surface, and a top surface of the transparent board 1101 is formed thereon a plurality of strip like arciform lens light gratings 1103 (that are shown as convex lens light gratings in this drawing) in combination and arranged in steps at the two lateral sides of a central line 1104 of the light distribution board to form mirror images one side to the other side. The strip like arciform lens light gratings 1103 formed on the top surface of the transparent board 1101 can also be concave lens light gratings or light gratings each contains convex and concave lenses. The curvature and inclination angle of each of the convex or concave lens light gratings 1103 are changed in pursuance of the angles of refraction of the incident light beams through the lens surfaces.

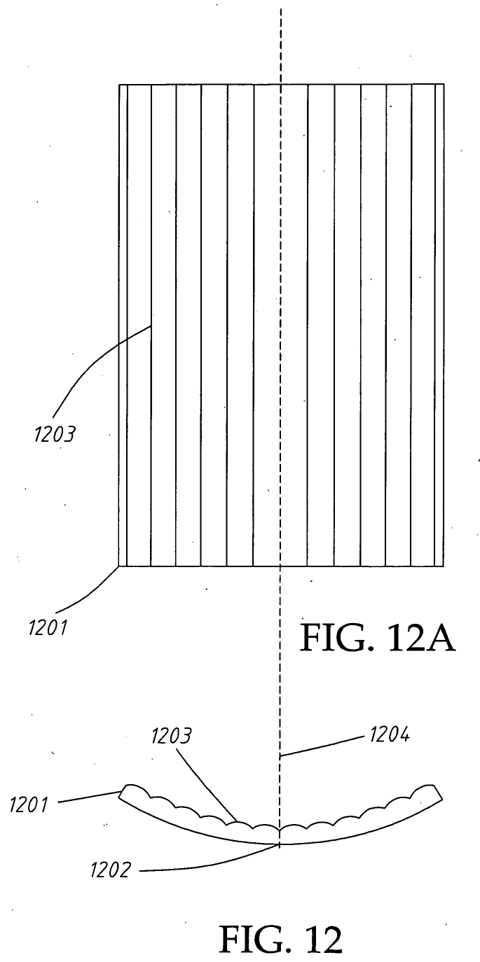

Referring to FIGS. 12 and 12A which are plane views of a fifth embodiment of light distribution board of the present invention, in the drawings, a bottom surface 1202 of a transparent board 1201 is an arc shaped surface, and a top surface of the transparent board 1201 is formed thereon a plurality of strip like arciform lens light gratings 1203 (that are shown as convex lens light gratings in this drawing) in combination and arranged in steps at the two lateral sides of a central line 1204 of the light distribution board to form mirror images one side to the other side. The strip like arciform lens light gratings 1203 formed on the top surface of the transparent board 1201 can also be concave lens light gratings or light gratings each contains convex and concave lenses. The curvature and inclination angle of each of the convex or concave lens light gratings 1203 are changed in pursuance of the angles of refraction of the incident light beams through the lens surfaces.

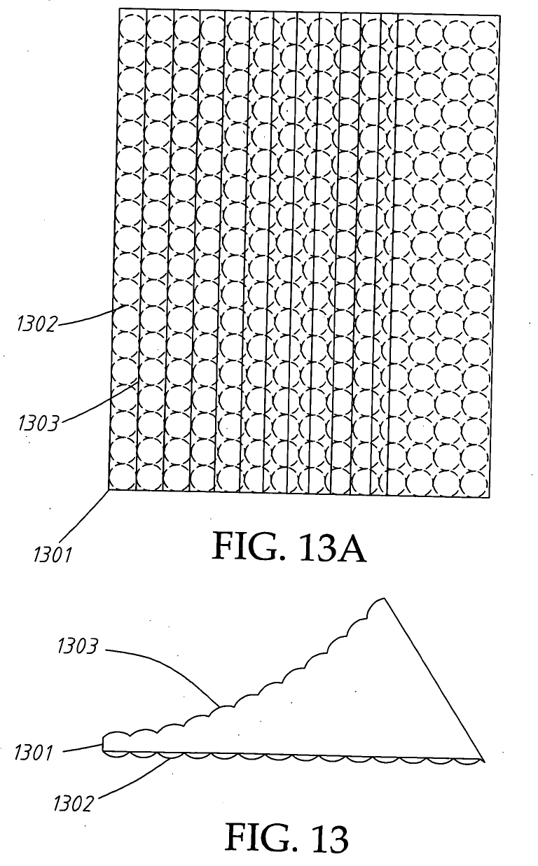

Referring to FIGS. 13 and 13A which are plane views of a sixth embodiment of light distribution board of the present invention, in the drawings, a bottom surface of a transparent board 1301 is formed thereon a plurality of granular convex lenses 1302 arranged in lines, and a top surface of the transparent board 1301 is formed thereon a plurality of strip like arciform lens light gratings 1303 (that are shown as convex lens light gratings in this drawing) in combination and arranged in steps. The strip like arciform lens light gratings 1303 formed on the top surface of the transparent board 1301 can also be concave lens light gratings or light gratings each containing convex and concave lenses. The curvature and inclination angle of each of the convex or concave lens light gratings 1303 are changed in pursuance of the angles of refraction of the incident light beams through the lens surfaces.

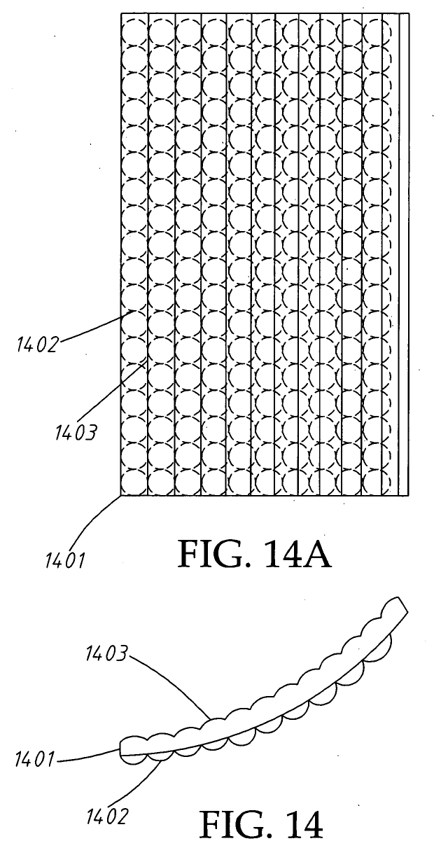

Referring to FIGS. 14 and 14A which are plane views of a seventh embodiment of light distribution board of the present invention, in the drawings, a bottom surface of a transparent board 1401 is formed thereon a plurality of granular convex lenses 1402 arranged in arcs, and a top surface of the transparent board 1401 is formed thereon a plurality of strip like arciform lens light gratings 1403 (that are shown as convex lens light gratings in this drawing) in combination and arranged in steps. The strip like arciform lens light gratings 1403 formed on the top surface of the transparent board 1401 can also be concave lens light gratings or light gratings each containing convex and concave lenses. The curvature and inclination angle of each of the convex or concave lens light gratings 1403 are changed in pursuance of the angles of refraction of the incident light beams through the lens surfaces.

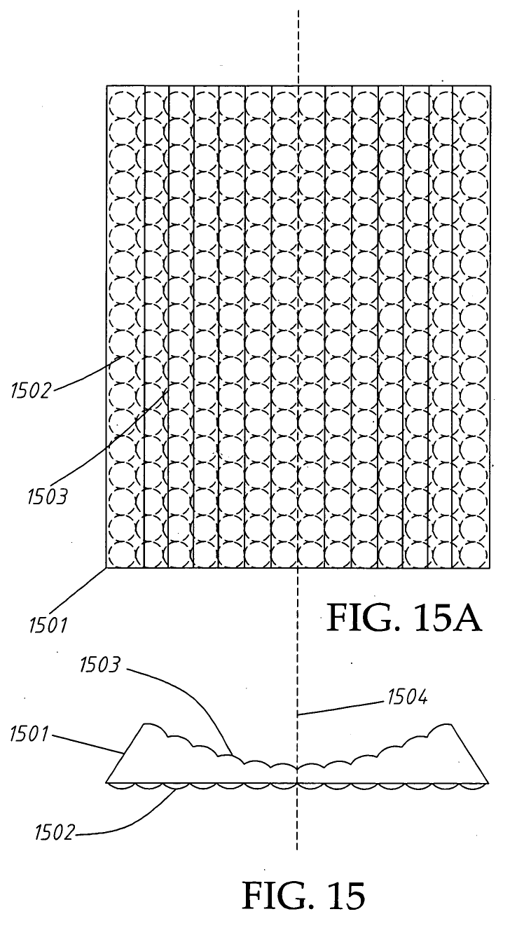

Referring to FIGS. 15 and 15A which are plane views of an eighth embodiment of light distribution board of the present invention, in the drawings, a bottom surface of a transparent board 1501 is formed thereon a plurality of granular convex lenses 1502 arranged in lines, and a top surface of the transparent board 1501 is formed thereon a plurality of strip like arciform lens light gratings 1503 (that are shown as convex lens light gratings in this drawing) in combination and arranged in steps at the two lateral sides of a central line 1504 of the light distribution board to form mirror images one side to the other side. The strip like arciform lens light gratings 1503 formed on the top surface of the transparent board 1501 can also be concave lens light gratings or light gratings each contains convex and concave lenses. The curvature and inclination angle of each of the convex or concave lens light gratings 1503 are changed in pursuance of the angles of refraction of the incident light beams through the lens surfaces.

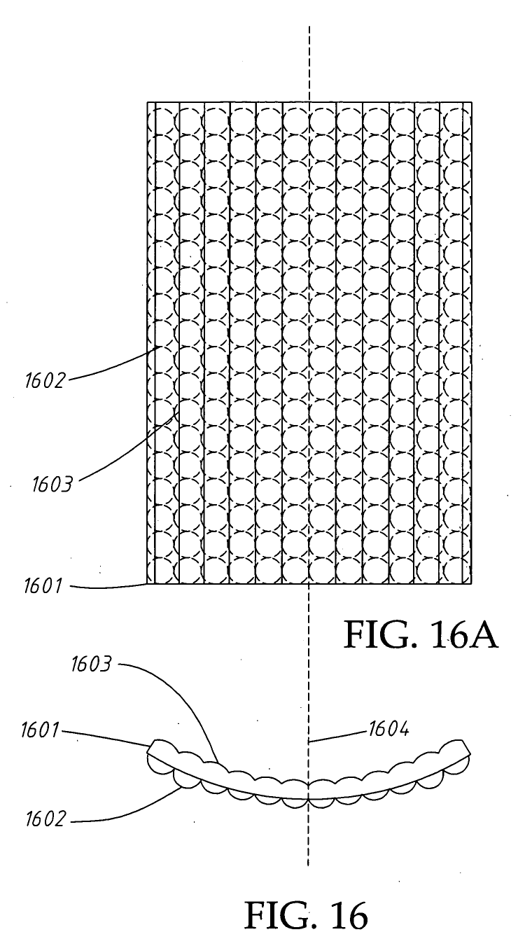

Referring to FIGS. 16 and 16A which are plane views of a ninth embodiment of light distribution board of the present invention, in the drawings, a bottom surface 1602 of a transparent board 1601 is formed thereon a plurality of granular convex lenses 1602 arranged in arcs, and a top surface of the transparent board 1601 is formed thereon a plurality of strip like arciform lens light gratings 1603 (that are shown as convex lens light gratings in this drawing) in combination and arranged in steps at the two lateral sides of a central line 1604 of the light distribution board to form mirror images one side to the other side. The strip like arciform lens light gratings 1603 formed on the top surface of the transparent board 1601 can also be concave lens light gratings or light gratings each contains convex and concave lenses. The curvature and inclination angle of each of the convex or concave lens light gratings 1603 are changed in pursuance of the angles of refraction of the incident light beams through the lens surfaces.

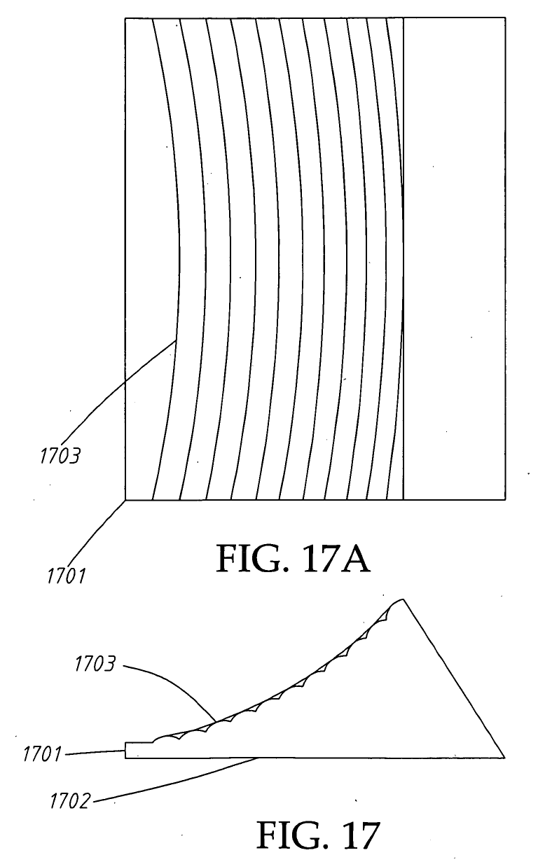

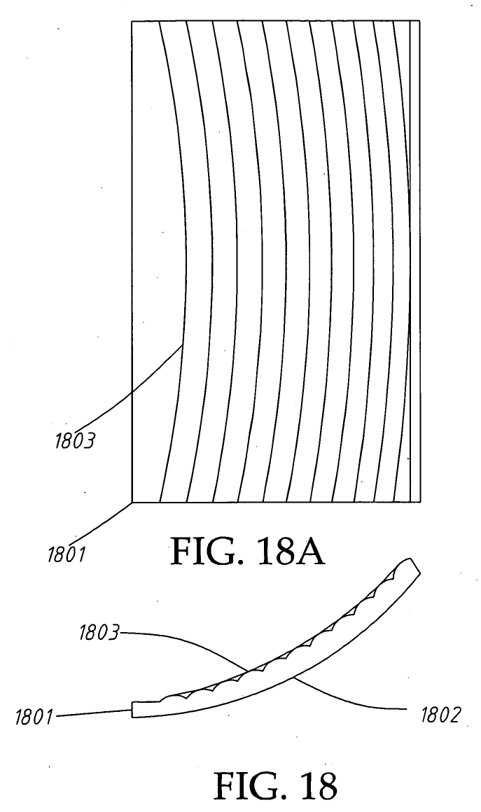

Referring to FIGS. 17 and 17A which are plane views of a tenth embodiment of light distribution board of the present invention, in the drawings, a bottom surface 1702 of a transparent board 1701 is a plane surface, and a top surface of the transparent board 1701 is formed thereon a plurality of concentric arc shaped arciform lens light gratings 1703 (that are shown as convex lens light gratings in this drawing) in combination and arranged in steps. The arc shaped arciform lens light gratings 1703 formed on the top surface of the transparent board 1701 can be concave lens light gratings or light gratings each contains convex and concave lenses. The curvature and inclination angle of each of the convex or concave lens light gratings 1703 of the transparent board 1701 are changed in pursuance of the angles of refraction of the incident light beams through the lens surfaces.

Referring to FIGS. 18 and 18A which are plane views of an eleventh embodiment of light distribution board of the present invention, in the drawings, a bottom surface 1802 of a transparent board 1801 is in an arc shape, and a top surface of the transparent board 1801 is formed thereon a plurality of concentric arc shaped arciform lens light gratings 1803 (that are shown as convex lens light gratings in this drawing) in combination and arranged in steps. The arc shaped arciform lens light gratings 1803 formed on the top surface of the transparent board 1801 can also be concave lens light gratings or light gratings each contains convex and concave lenses. The curvature and inclination angle of each of the convex or concave lens light gratings 1803 of the transparent board 1801 are changed in pursuance of the angles of refraction of the incident light beams through the lens surfaces.

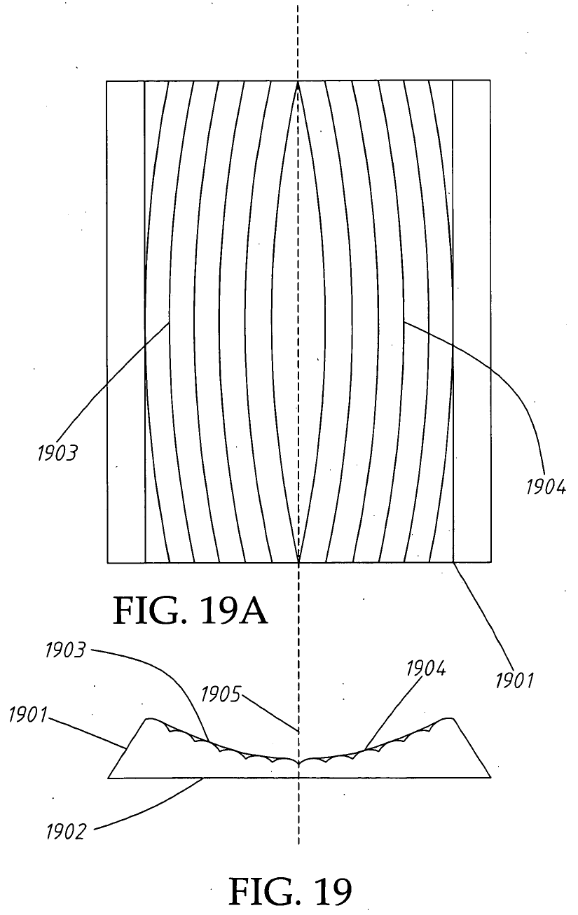

Referring to FIGS. 19 and 19A which are plane views of a twelfth embodiment of light distribution board of the present invention, in the drawings, a bottom surface 1902 of a transparent board 1901 is a plane surface, and a top surface of the transparent board 1901 is formed thereon a plurality of non-concentric arc shaped arciform lens light gratings 1903, 1904 (that are shown as convex lens light gratings in this drawing) in combination and arranged in steps at the two lateral sides of a central line 1905 of the light distribution board to form mirror images one side to the other side. The arc shaped arciform lens light gratings 1903 formed on the top surface of the transparent board 1901 can also be concave lens light gratings or light gratings each contains convex and concave lenses. The curvature and inclination angle of each of the convex or concave lens light gratings 1903 are changed in pursuance of the angles of refraction of the incident light beams through the lens surfaces.

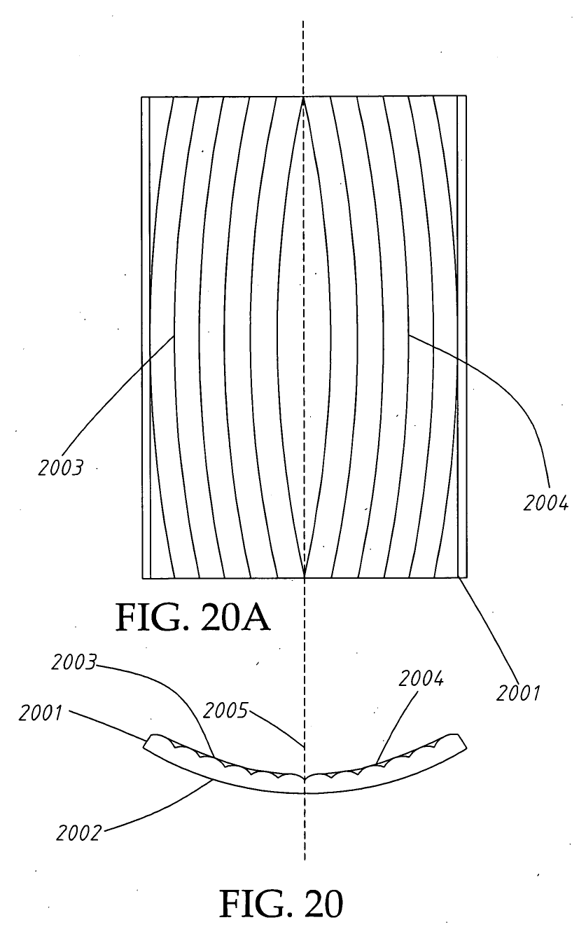

Referring to FIGS. 20 and 20A which are plane views of a thirteenth embodiment of light distribution board of the present invention, in the drawings, a bottom surface 2002 of a transparent board 2001 is an arc shaped surface, and a top surface of the transparent board 2001 is formed thereon a plurality of non-concentric arc shaped arciform lens light gratings 2003, 2004 (that are shown as convex lens light gratings in this drawing) in combination and arranged in steps at the two lateral sides of a central line 2005 of the light distribution board to form mirror images one side to the other side. The arc shaped arciform lens light gratings 2003 formed on the top surface of the transparent board 2001 can also be concave lens light gratings or light gratings each contains convex and concave lenses. The curvature and inclination angle of each of the convex or concave lens light gratings 2003 are changed in pursuance of the angles of refraction of the incident light beams through the lens surfaces.

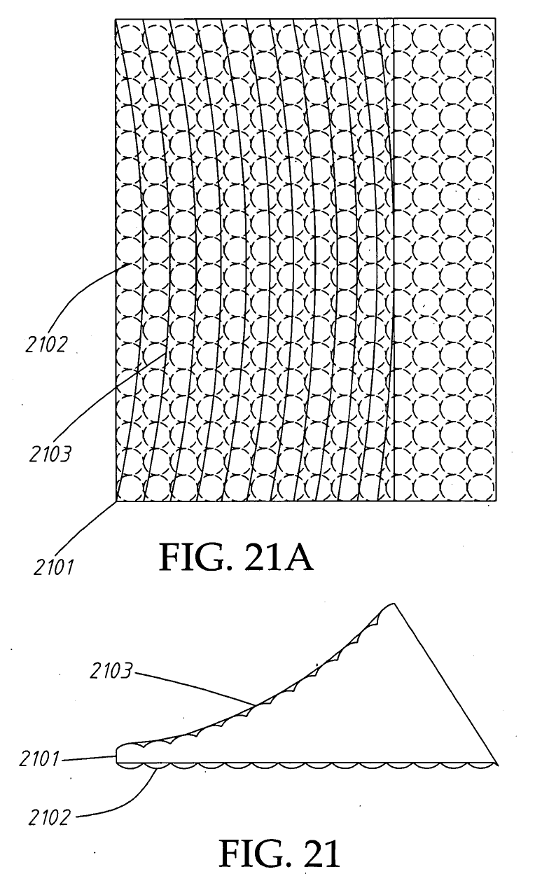

Referring to FIGS. 21 and 21A which are plane views of a fourteenth embodiment of light distribution board of the present invention, in the drawings, a bottom surface of a transparent board 2101 is formed thereon a plurality of granular convex lenses 2102 arranged in lines, and a top surface of the transparent board 2101 is formed thereon a plurality of concentric arc shaped arciform lens light gratings 2103 (that are shown as convex lens light gratings in this drawing) in combination and arranged in steps. The arc shaped arciform lens light gratings 2103 formed on the top surface of the transparent board 2101 can also be concave lens light gratings or light gratings each contains convex and concave lenses. The curvature and inclination angle of each of the convex or concave lens light gratings 2103 of the transparent board 2101 are changed in pursuance of the angles of refraction of the incident light beams through the lens surfaces.

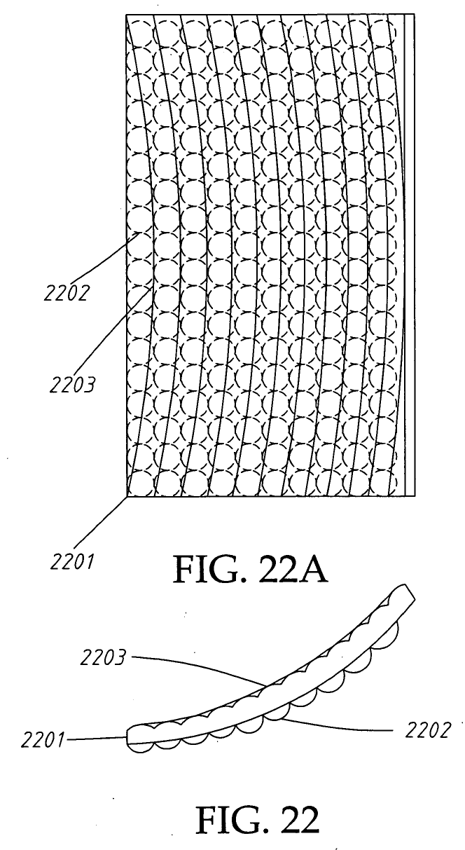

Referring to FIGS. 22 and 22A which are plane views of a fifteenth embodiment of light distribution board of the present invention, in the drawings, a bottom surface of a transparent board 2201 is formed thereon a plurality of granular convex lenses 2202 arranged in arcs, and a top surface of the transparent board 2201 is formed thereon a plurality of concentric arc shaped convex lens light gratings 2203 in combination and arranged in steps. The arc shaped arciform lens light gratings 2203 (that are shown as convex lens light gratings in this drawing) formed on the top surface of the transparent board 2201 can also be concave lens light gratings or light gratings each contains convex and concave lenses. The curvature and inclination angle of each of the convex or concave lens light gratings 2203 of the transparent board 2201 are changed in pursuance of the angles of refraction of the incident light beams through the lens surfaces.

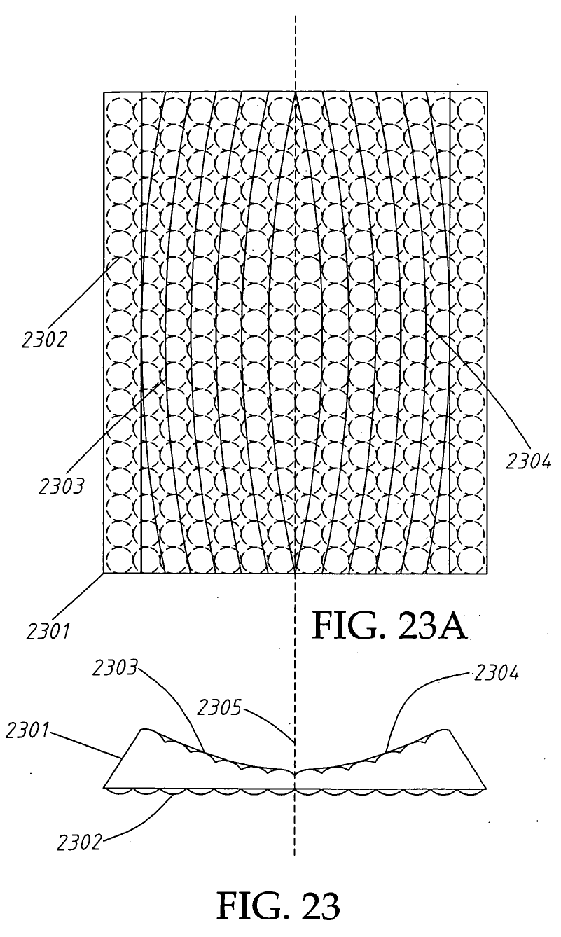

Referring to FIGS. 23 and 23A which are plane views of a sixteenth embodiment of light distribution board of the present invention, in the drawings, a bottom surface 2302 of a transparent board 2301 is formed thereon a plurality of granular convex lenses 2302 arranged in lines, and a top surface of the transparent board 2301 is formed thereon two groups of non-concentric arc shaped arciform lens light gratings 2303, 2304 (that are shown as convex lens light gratings in this drawing) in combination and arranged in steps at the two lateral sides of a central line 2305 of the light distribution board to form mirror images one side to the other side. The arc shaped arciform lens light gratings 2303 formed on the top surface of the transparent board 2301 can also be concave lens light gratings or light gratings each contains convex and concave lenses. The curvature and inclination angle of each of the convex or concave lens light gratings 2303 are changed in pursuance of the angles of refraction of the incident light beams through the lens surfaces.

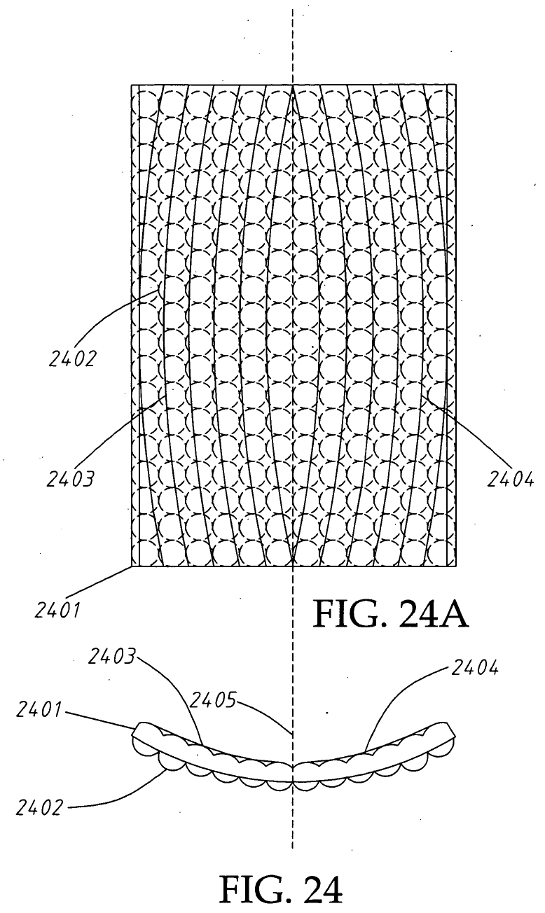

Referring to FIGS. 24 and 24A which are plane views of a seventeenth embodiment of light distribution board of the present invention, in the drawings, a bottom surface of a transparent board 2401 is formed thereon a plurality of granular convex lenses 2402 arranged in arcs, and a top surface of the transparent board 2401 is formed thereon two groups of non-concentric arc shaped arciform lens light gratings 2403, 2404 (that are shown as convex lens light gratings in this drawing) in combination and arranged in steps at the two lateral sides of a central line 2405 of the light distribution board to form mirror images one side to the other side. The arc shaped arciform lens light gratings 2403 formed on the top surface of the transparent board 2401 can also be concave lens light gratings or light gratings each contains convex and concave lenses. The curvature and inclination angle of each of the convex or concave lens light gratings 2403 are changed in pursuance of the angles of refraction of the incident light beams through the lens surfaces.

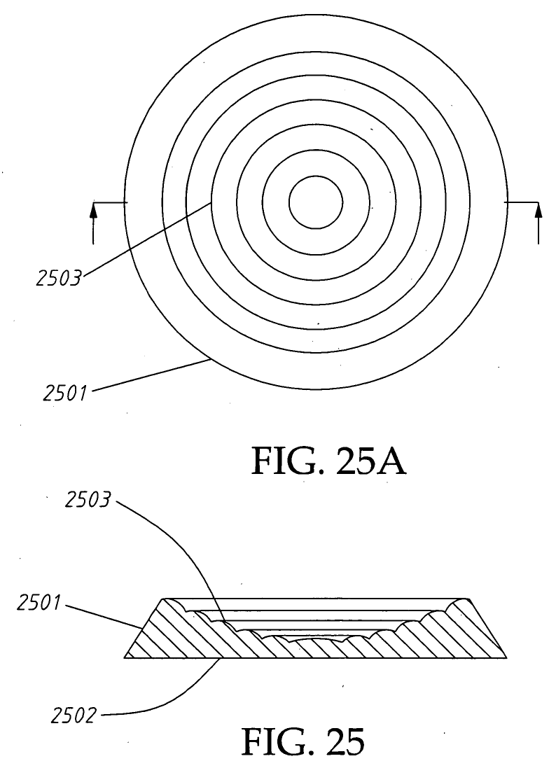

Referring to FIGS. 25 and 25A which are plane views of an eighteenth embodiment of light distribution board of the present invention, in the drawings, a bottom surface 2502 of a transparent board 2501 is a plane surface, and a top surface of the transparent board 2501 is formed thereon a plurality of concentric annular arciform lens light gratings 2503 (that are shown as convex lens light gratings in this drawing) in combination and arranged in steps. The annular arciform lens light gratings 2503 formed on the top surface of the transparent board 2501 can also be concave lens light gratings or light gratings each contains convex and concave lenses. The curvature and inclination angle of each of the convex or concave lens light gratings 2503 are changed in pursuance of the angles of refraction of the incident light beams through the lens surfaces.

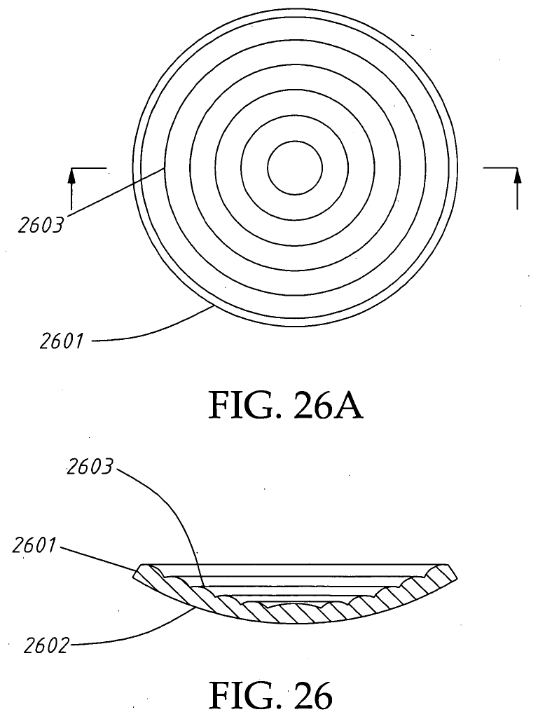

Referring to FIGS. 26 and 26A which are plane views of a nineteenth embodiment of light distribution board of the present invention, in the drawings, a bottom surface 2602 of a transparent board 2601 is in an arc shape, and a top surface of the transparent board 2601 is formed thereon a plurality of concentric annular arciform lens light gratings 2603 (that are shown as convex lens light gratings in this drawing) in combination and arranged in steps. The annular arciform lens light gratings 2603 formed on the top surface of the transparent board 2601 can also be concave lens light gratings or light gratings each contains convex and concave lenses. The curvature and inclination angle of each of the convex or concave lens light gratings 2603 are changed in pursuance of the angles of refraction of the incident light beams through the lens surfaces.

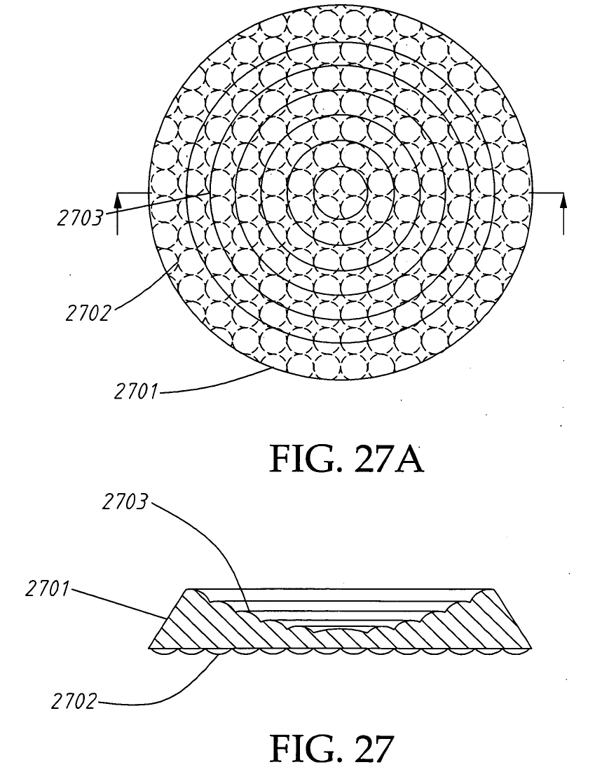

Referring to FIGS. 27 and 27A which are plane views of a twentieth embodiment of light distribution board of the present invention, in the drawings, a bottom surface of a transparent board 2701 is formed thereon a plurality of granular convex lenses 2702 arranged in lines, and a top surface of the transparent board 2701 is formed thereon a plurality of concentric annular arciform lens light gratings 2703 in combination and arranged in steps. The annular arciform lens light gratings 2703 (that are shown as convex lens light gratings in this drawing) formed on the top surface of the transparent board 2701 can also be concave lens light gratings or light gratings each contains convex and concave lenses. The curvature and inclination angle of each of the convex or concave lens light gratings 2703 of the transparent board 2701 are changed in pursuance of the angles of refraction of the incident light beams through the lens surfaces.

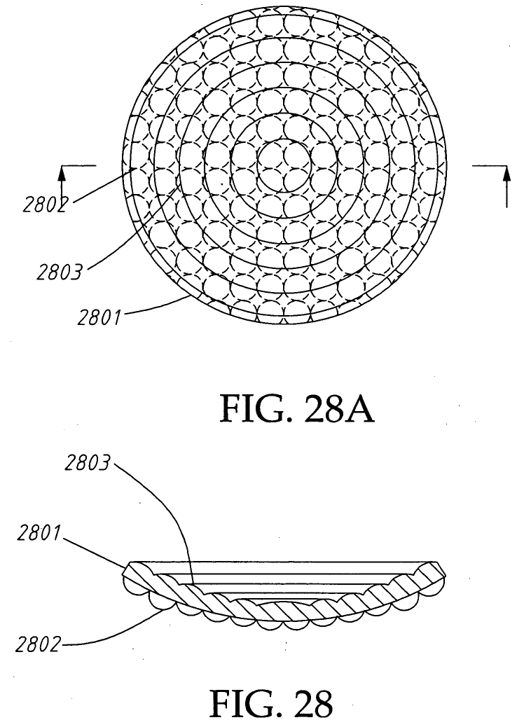

Referring to FIGS. 28 and 28A which are plane views of a twenty first second embodiment of light distribution board of the present invention, in the drawings, a bottom surface of a transparent board 2801 is formed thereon a plurality of granular convex lenses 2802 arranged in arcs, and a top surface of the transparent board 2801 is formed thereon a plurality of concentric annular arciform lens light gratings 2803 (that are shown as convex lens light gratings in this drawing) in combination and arranged in steps. The annular arciform lens light gratings 2803 formed on the top surface of the transparent board 2801 can also be concave lens light gratings or light gratings each contains convex and concave lenses. The curvature and inclination angle of each of the convex or concave lens light gratings 2803 of the transparent board 2801 are changed in pursuance of the angles of refraction of the incident light beams through the lens surfaces.

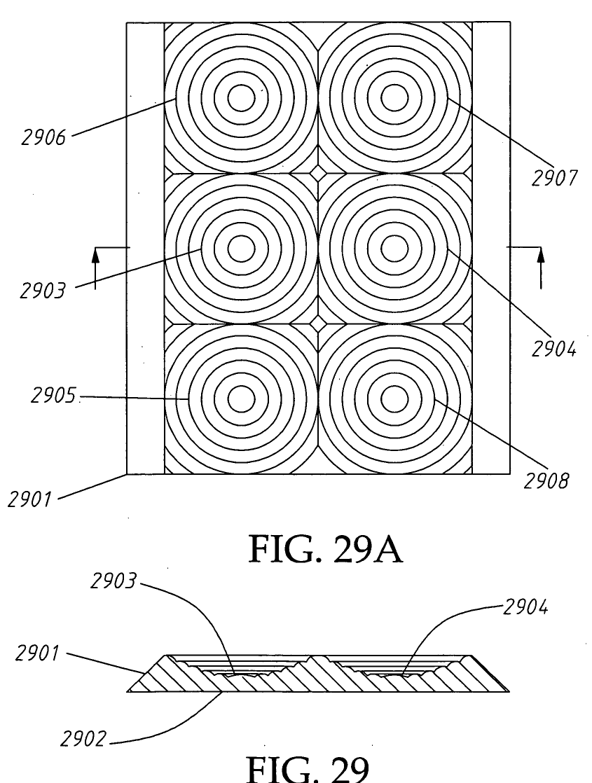

Referring to FIGS. 29 and 29A which are plane views of a twenty second embodiment of light distribution board of the present invention, in the drawings, a bottom surface 2902 of a transparent board 2901 is a plane surface, and a top surface of the transparent board 2901 is formed thereon a plurality of non-concentric annular arciform lens light gratings 2903, 2904, 2905, 2906, 2907 (that are shown as convex lens light gratings in this drawing) and 2908 in combination and arranged in steps. The annular arciform light gratings formed on the top surface of the transparent board 2901 can also be concave lens light gratings or light gratings each contains convex and concave lenses. The curvature and inclination angle of each of the convex or concave lens light gratings are changed in pursuance of the angles of refraction of the incident light beams through the lens surfaces.

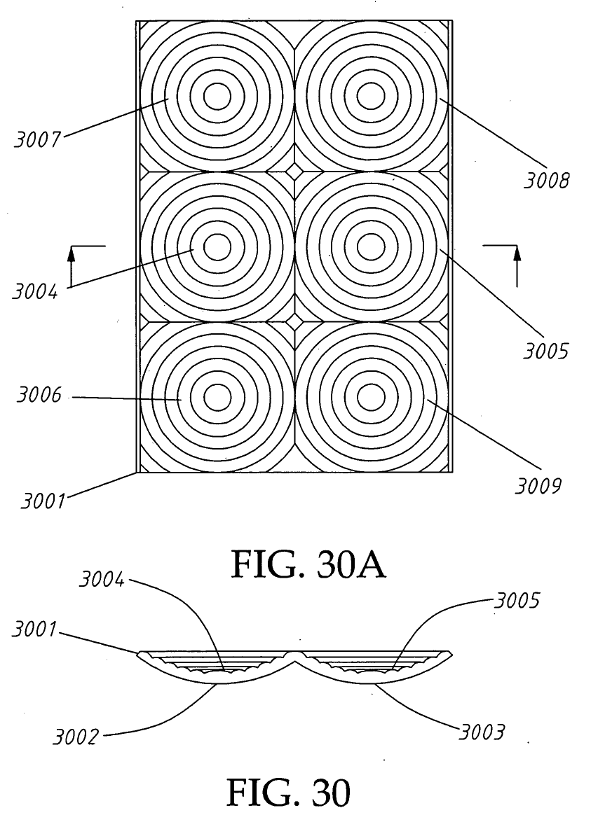

Referring to FIGS. 30 and 30A which are plane views of a twenty third embodiment of light distribution board of the present invention, in the drawings, a bottom surface of a transparent board 3001 has two arc shaped surfaces 3002, 3003, and a top surface of the transparent board 3001 is formed thereon a plurality of non-concentric annular convex lens light gratings 3004, 3005, 3006, 3007, 3008 and 3009 (that are shown as convex lens light gratings in this drawing) in combination and arranged in steps. The annular arciform lens light gratings formed on the top surface of the transparent board 3001 can also be concave lens light gratings or light gratings each contains convex and concave lenses. The curvature and inclination angle of each of the convex or concave lens light gratings are changed in pursuance of the angles of refraction of the incident light beams through the lens surfaces.

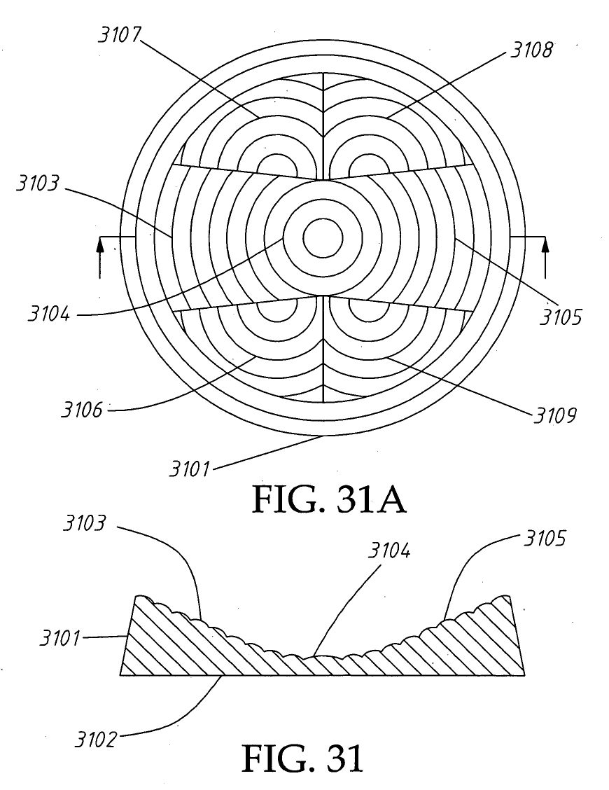

Referring to FIGS. 31 and 31A which are plane views of a twenty fourth embodiment of light distribution board of the present invention, in the drawings, a bottom surface 3102 of a transparent board 3101 is a plane surface, and a top surface of the transparent board 3101 is formed thereon a plurality of concentric annular arciform lens light gratings 3104, a plurality of concentric arc shaped arciform lens light gratings 3103, 3105 and a plurality of non-concentric arc shaped arciform lens light gratings 3106, 3107, 3108 and 3109 (all these arciform lens light gratings are shown as convex lens light gratings in this drawing) all in combination and arranged in steps. The annular and arc shaped arciform lens light gratings formed on the top surface of the transparent board can also be concave lens light gratings or light gratings each contains convex and concave lenses. The curvature and inclination angle of each of the convex or concave lens light gratings are changed in pursuance of the angles of refraction of the incident light beams through the lens surfaces.

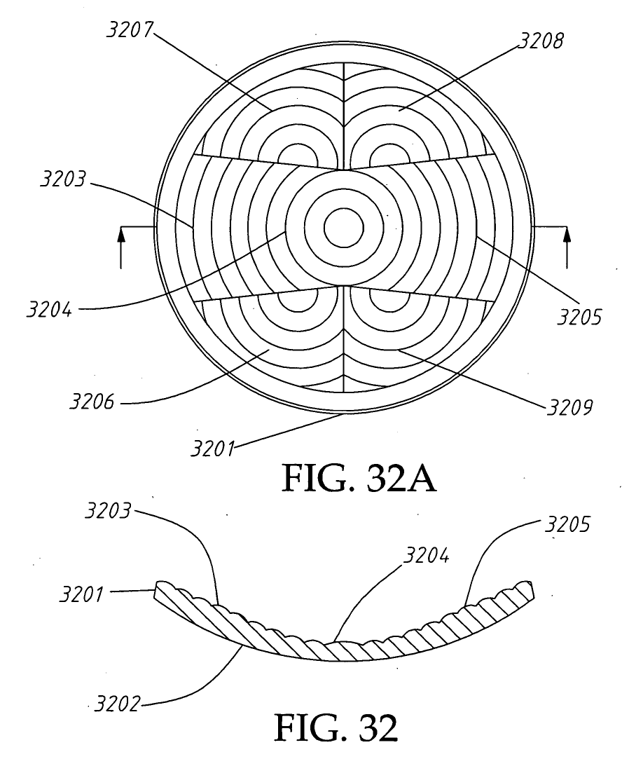

Referring to FIGS. 32 and 32A which are plane views of a twenty fifth embodiment of light distribution board of the present invention, in the drawings, a bottom surface 3202 of a transparent board 3201 is in an arc shape, and a top surface of the transparent board 3201 is formed thereon a plurality of concentric annular arciform lens light gratings 3204, a plurality of concentric arc shaped arciform lens light gratings 3203, 3205 and a plurality of non-concentric arc shaped arciform lens light gratings 3206, 3207, 3208 and 3209 (all these arciform lens light gratings are shown as convex lens light gratings in this drawing) all in combination and arranged in steps. The annular and arc shaped arciform lens light gratings formed on the top surface of the transparent board can also be concave lens light gratings or light gratings each contains convex and concave lenses. The curvature and inclination angle of each of the convex or concave lens light gratings are changed in pursuance of the angles of refraction of the incident light beams through the lens surfaces.

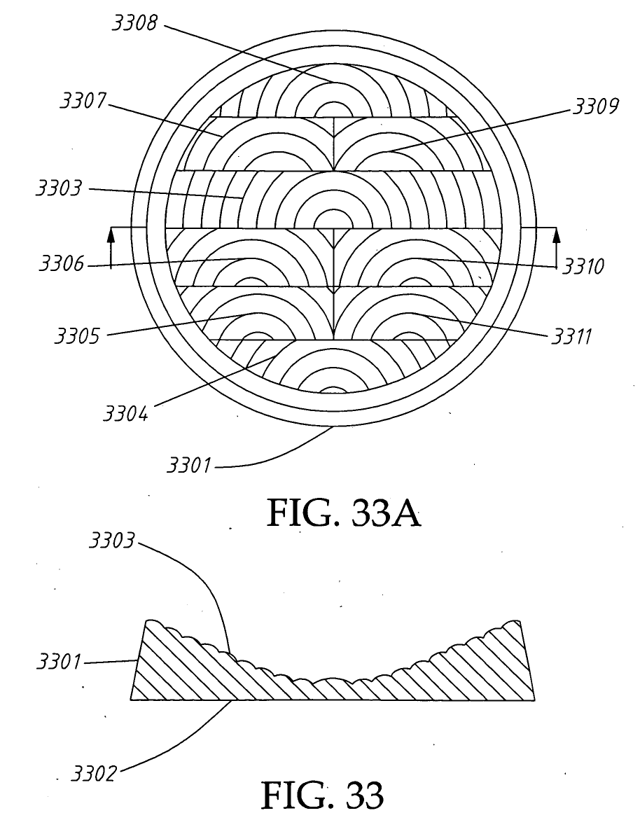

Referring to FIGS. 33 and 33A which are plane views of a twenty sixth embodiment of light distribution board of the present invention, in the drawings, a bottom surface 3302 of a transparent board 3301 is a plane surface, and a top surface of the transparent board 3301 is formed thereon a plurality of non-concentric arc shaped arciform lens light gratings 3303, 3304, 3305, 3306, 3307, 3308, 3309, 3310, and 3311 (that are shown as convex lens light gratings in this drawing) all in combination and arranged in steps. The arc shaped arciform lens light gratings formed on the top surface of the transparent board can also be concave lens light gratings or light gratings each contains convex and concave lenses. The curvature and inclination angle of each of the convex or concave lens light gratings are changed in pursuance of the angles of refraction of the incident light beams through the lens surfaces.

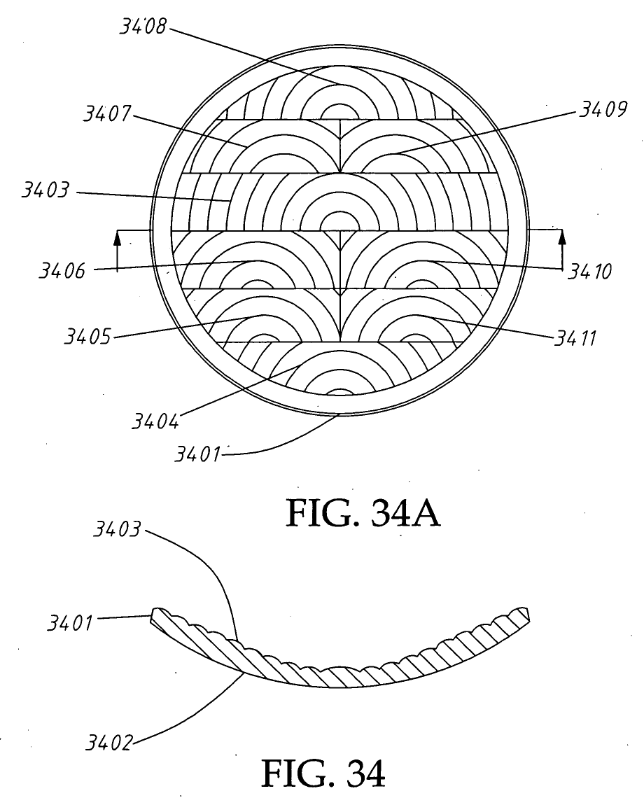

Referring to FIGS. 34 and 34A which are plane views of a twenty seventh embodiment of light distribution board of the present invention, in the drawings, a bottom surface 3402 of a transparent board 3401 is an arc shaped surface, and a top surface of the transparent board 3401 is formed thereon a plurality of non-concentric arc shaped arciform lens light gratings 3403, 3404, 3405, 3406, 3407, 3408, 3409, 3410, and 3411 (that are shown as convex lens light gratings in this drawing) all in combination and arranged in steps. The arc shaped arciform lens light gratings formed on the top surface of the transparent board can also be concave lens light gratings or light gratings each contains convex and concave lenses. The curvature and inclination angle of each of the convex or concave lens light gratings are changed in pursuance of the angles of refraction of the incident light beams through the lens surfaces.

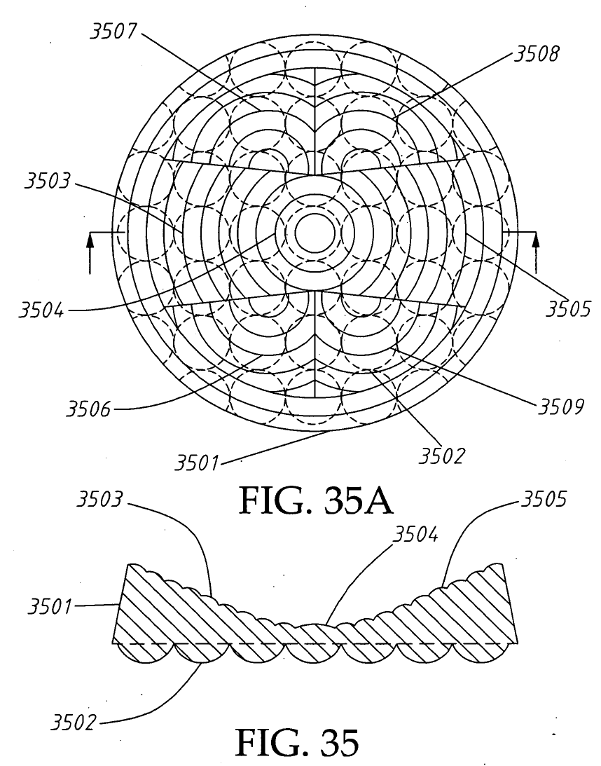

Referring to FIGS. 35 and 35A which are plane views of a twenty eighty embodiment of light distribution board of the present invention, in the drawings, a bottom surface of a transparent board 3501 is formed thereon a plurality of granular convex lenses 3502 arranged in lines, and a top surface of the transparent board 3501 is formed thereon a plurality of concentric annular convex lens light gratings 3504, a plurality of concentric arc shaped arciform lens light gratings 3503, 3505, and a plurality of non-concentric arc shaped convex lens light gratings 3506, 3507, 3508 and 3509 (that are shown as convex lens light gratings in this drawing) all in combination and arranged in steps. The annular and arc shaped arciform lens light gratings formed on the top surface of the transparent board can also be concave lens light gratings or light gratings each contains convex and concave lenses. The curvature and inclination angle of each of the convex or concave lens light gratings are changed in pursuance of the angles of refraction of the incident light beams through the lens surfaces.

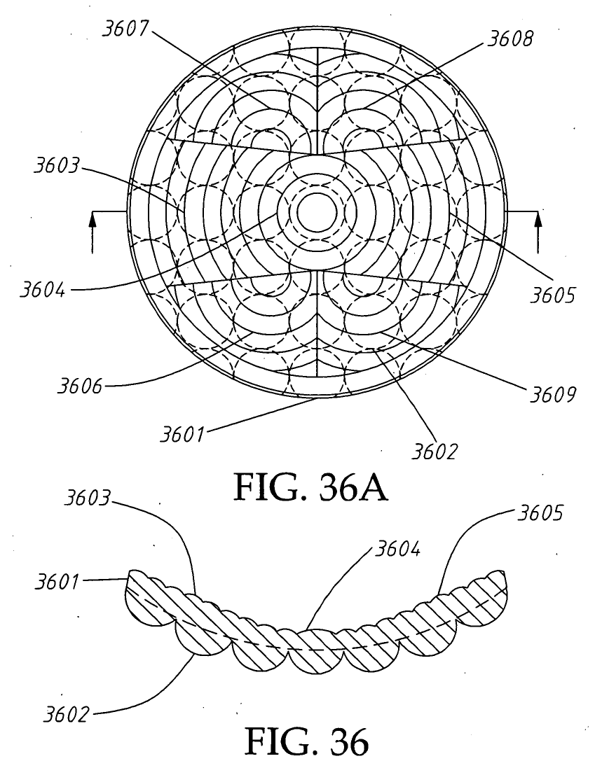

Referring to FIGS. 36 and 36A which are plane views of a twenty ninth embodiment of light distribution board of the present invention, in the drawings, a bottom surface of a transparent board 3601 is formed thereon a plurality of granular convex lenses 3602 arranged in arcs, and a top surface of the transparent board 3601 is formed thereon a plurality of concentric annular arciform lens light gratings 3604, a plurality of concentric arc shaped arciform lens light gratings 3603, 3605, and a plurality of non-concentric arc shaped arciform lens light gratings 3606, 3607, 3608 and 3609 (all these arciform lens light gratings are shown as convex lens light gratings in this drawing) all in combination and arranged in steps. The annular and arc shaped arciform lens light gratings formed on the top surface of the transparent board can also be concave lens light gratings or light gratings each contains convex and concave lenses. The curvature and inclination angle of each of the convex or concave lens light gratings are changed in pursuance of the angles of refraction of the incident light beams through the lens surfaces.

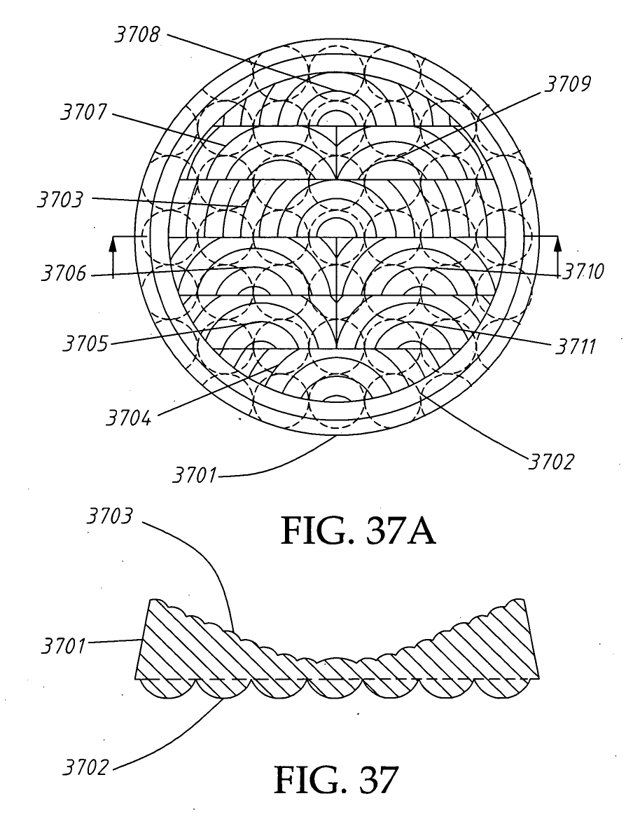

Referring to FIGS. 37 and 37A which are plane views of a thirtieth embodiment of light distribution board of the present invention, in the drawings, a bottom surface of a transparent board 3701 is formed thereon a plurality of granular convex lenses 3702 arranged in lines, and a top surface of the transparent board 3701 is formed thereon a plurality of non-concentric arc shaped arciform lens light gratings 3703, 3704, 3705, 3706, 3707, 3708, 3709, 3710, and 3711 (that are shown as convex lens light gratings in this drawing) all in combination and arranged in steps. The arc shaped arciform lens light gratings formed on the top surface of the transparent board can also be concave lens light gratings or light gratings each contains convex and concave lenses. The curvature and inclination angle of each of the convex or concave lens light gratings are changed in pursuance of the angles of refraction of the incident light beams through the lens surfaces.

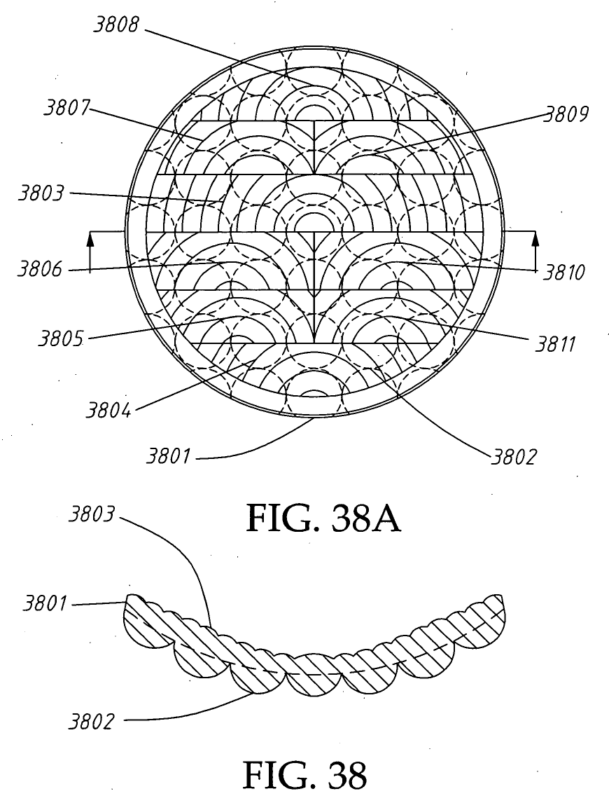

Referring to FIGS. 38 and 38A which are plane views of a thirty first embodiment of light distribution board of the present invention, in the drawings, a bottom surface of a transparent board 3801 is formed thereon a plurality of granular convex lenses 3802 arranged in arcs, and a top surface of the transparent board 3801 is formed thereon a plurality of non-concentric arc shaped arciform lens light gratings 3803, 3804, 3805, 3806, 3807, 3808, 3809, 3810, and 3811 (that are shown as convex lens light gratings in this drawing) all in combination and arranged in steps. The arc shaped arciform lens light gratings formed on the top surface of the transparent board can also be concave lens light gratings or light gratings each contains convex and concave lenses. The curvature and inclination angle of each of the convex or concave lens light gratings are changed in pursuance of the angles of refraction of the incident light beams through the lens surfaces.

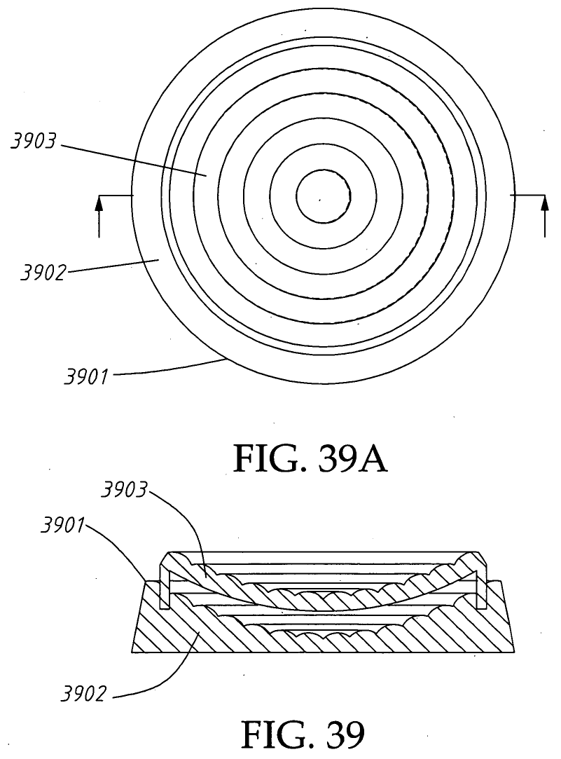

Referring to FIGS. 39 and 39A which are plane views of a thirty second embodiment of light distribution board of the present invention; in the drawings, there is a two-layer light distribution board 3901 composed of two transparent boards 3902, 3903 of which one overlaps the other, each of the two transparent boards 3902, 3903 can be any one of the above first to thirty first embodiments of light distribution boards. The two transparent boards 3902, 3903 as shown here are the transparent boards respectively as stated in the eighteenth and nineteenth embodiments, with such a structure, light beams can get maximum angles of refraction after many times of refraction.

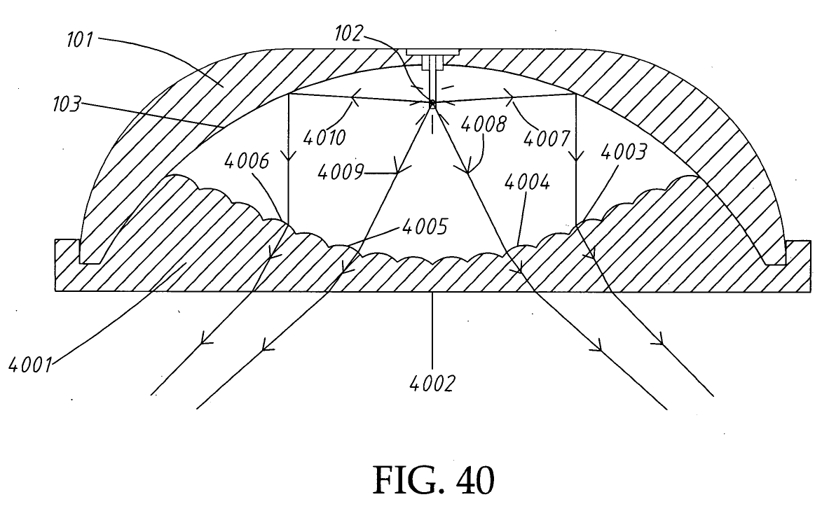

Referring to FIG. 40 which shows an embodiment of which at least a side respectively of at least a transparent board of the present invention is used to form a light distribution board with a plurality of arciform lens light gratings and is applied to a lamp set, in which a light distribution board randomly chosen from any of the above first to thirty first embodiments is movably mounted at a district to be illuminated below a conventional half covering type obscured cover 101; in this drawing, a light distribution board 4001 as that of the eighteenth embodiment of the present invention is used for an example, a top surface of the light distribution board 4001 is formed thereon a plurality of annular convex lens light gratings facing to a light source 102 for being a light receiving surface, a bottom surface 4002 of the light distribution board 4001 is a plane surface as a light outputting surface.

When a light beam 4008 enters a convex lens 4004 of the light distribution board 4001 to create a first time refraction, and when the light beam 4008 reaches the plane surface 4002, it is once more refracted down and leftwards toward a district to be illuminated. A light beam 4009 enters a convex lens light grating 4005 of the light distribution board 4001 to create a first time refraction, and when the light beam 4009 reaches the plane surface 4002, it is once more refracted down and leftwards and enters the district to be illuminated. A light beam 4007 reflected by a reflective cover 103 enters a convex lens light grating 4003 of the light distribution board 4001 to create a first time refraction, and when the light beam 4007 reaches the plane surface 4002, it is once more refracted down and rightwards and enters the district to be illuminated. A light beam 4010 enters a light grating 4006 of the light distribution board 4001 after being reflected by a reflective surface 103 to create a first time refraction, and when the light beam 4010 reaches the plane surface 4002, it is once more refracted down and rightwards and enters the district to be illuminated. The light distribution board 4001 surely can control illumination of a specific district to be illuminated by most of the light beams from the lamp set, and the effects of having a wider illuminated range and uniform distribution of brightness of light beams at the district to be illuminated can be obtained, and an effect of saving energy and dazzle proofing can thus be achieved.

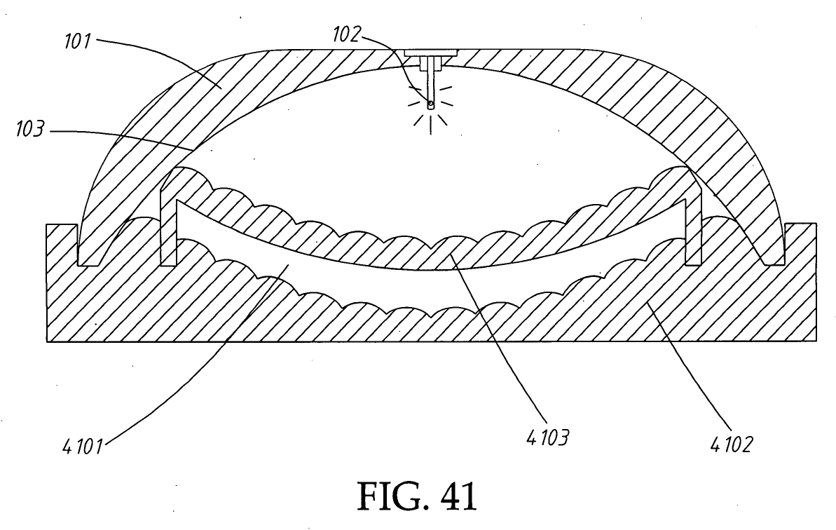

Referring to FIG. 41 which shows another embodiment of which at least a side respectively of at least a transparent board of the present invention is used to form a light distribution board with a plurality of arciform lens light gratings and is applied to a lamp set, in which a light distribution board 4101 chosen from the above thirty second embodiment is movably mounted at a district to be illuminated below the conventional half covering type obscured cover 101; in this drawing, the light distribution board 4101 is formed from two transparent boards 4102, 4103 of which one overlaps the other.

By virtue that there are many kinds of embodiments provided, all these light distribution boards of the present invention can be applied respectively to a light outputting surface of a conventional lamp set in lieu of a conventional lamp shade, thus a lamp set with a light distribution board of the present invention can be formed.

In conclusion, by specifically designing on light gratings, the light distribution boards of the present invention can certainly get the expected effects thereof when being used on a lamp set. Having thus described my invention that meets the requirement of elements for patent application, what I claim as new and desire to be secured by Letters Patent of the United States is:

1. A light distribution board having multiple light gratings each with many arciform (convex or concave) lenses, said light distribution board is used on a light outputting surface of a lamp shade of an illuminating lamp set to control refraction angular directions of light beams of said lamp set, so that said light beams irradiate a district to be illuminated to get an effect of uniformly distributing, said lamp set includes said obscured lamp shade, at least a reflective cover and at least a light source; said light distribution board having a plurality of light gratings each with many arciform lenses includes at least a transparent board formed respectively on at least one side thereof a plurality of arciform lens light gratings, said light distribution board is characterized in that: said arciform lens light gratings are arranged in lines, curvature and inclination angle of each of said arciform lens light gratings are changed in pursuance of the angles of refraction of the incident light beams through the lens surfaces.

2. The light distribution board having multiple light gratings each with many arciform (convex or concave) lenses as in claim 1, wherein: said at least one side is a top surface, said arciform lens light gratings are formed on said top surface of said transparent board and are strip like light gratings, said top surface is a light receiving surface of said lamp set, a bottom surface of said transparent board is a plane, bevel or arc shaped surface or is formed thereon a plurality of granular convex lenses and is an illuminating surface of said lamp set.

3. The light distribution board having multiple light gratings each with many arciform (convex or concave) lenses as in claim 1, wherein: said at least one side is a top surface, said arciform lens light gratings are formed on said top surface of said transparent board and are concentric annular light gratings, said top surface is a light receiving surface of said lamp set, a bottom surface of said transparent board is a plane, bevel or arc shaped surface or is form thereon a plurality of granular convex lenses and is an illuminating surface of said lamp set.

4. The light distribution board having multiple light gratings each with many arciform (convex or concave) lenses as in claim 1, wherein: said at least one side is a top surface, said arciform lens light gratings are formed on said top surface of said transparent board and are concentric arc shaped light gratings, said top surface is a light receiving surface of said lamp set, a bottom surface of said transparent board is a plane, bevel or arc shaped surface or is form thereon a plurality of granular convex lenses and is an illuminating surface of said lamp set.

5. The light distribution board having multiple light gratings each with many arciform (convex or concave) lenses as in claim 1, wherein: said at least one side is a top surface, said arciform lens light gratings are formed on said top surface of said transparent board and are strip like light gratings arranged at two lateral sides of a central line of said light distribution board to form mirror images one side to other side, said top surface is a light receiving surface of said lamp set, a bottom surface of said transparent board is a plane, bevel or arc shaped surface or is form thereon a plurality of granular convex lenses and is an illuminating surface of said lamp set.

6. The light distribution board having multiple light gratings each with many arciform (convex or concave) lenses as in claim 1, wherein: said at least one side is a top surface, said arciform lens light gratings are formed on said top surface of said transparent board and are non-concentric arc shaped light gratings arranged at two lateral sides of a central line of said light distribution board to form mirror images one side to other side, said top surface is a light receiving surface of said lamp set, a bottom surface of said transparent board is a plane, bevel or arc shaped surface or is form thereon a plurality of granular convex lenses and is an illuminating surface of said lamp set.

7. The light distribution board having multiple light gratings each with many arciform (convex or concave) lenses as in claim 1, wherein: said at least one side is a top surface, said arciform lens light gratings are formed on said top surface of said transparent board and are non-concentric annular light gratings, said top surface is a light receiving surface of said lamp set, a bottom surface of said transparent board is a plane, bevel or arc shaped surface or is form thereon a plurality of granular convex lenses and is an illuminating surface of said lamp set.

8. The light distribution board having multiple light gratings each with many arciform (convex or concave) lenses as in claim 1, wherein: said at least one side is a top surface, said arciform lens light gratings are formed on said top surface of said transparent board and are a plurality of non-concentric annular light gratings and a plurality of non-concentric arc shaped light gratings in combination, said top surface is a light receiving surface of said lamp set, a bottom surface of said transparent board is a plane, bevel or arc shaped surface or is form thereon a plurality of granular convex lenses and is an illuminating surface of said lamp set.

9. The light distribution board having multiple light gratings each with many arciform (convex or concave) lenses as in claim 1, wherein: said at least one side is a top surface, said arciform lens light gratings are formed on said top surface of said transparent board and are a plurality of non-concentric annular light gratings and a plurality of concentric arc shaped light gratings in combination, said top surface is a light receiving surface of said lamp set, a bottom surface of said transparent board is a plane, bevel or arc shaped surface or is form thereon a plurality of granular convex lenses and is an illuminating surface of said lamp set.

10. The light distribution board having multiple light gratings each with many arciform (convex or concave) lenses as in claim 1, wherein: said at least one side is a top surface, said arciform lens light gratings are formed on said top surface of said transparent board and are a plurality of concentric annular light gratings and a plurality of non-concentric arc shaped light gratings in combination, said top surface is a light receiving surface of said lamp set, a bottom surface of said transparent board is a plane, bevel or arc shaped surface or is form thereon a plurality of granular convex lenses and is an illuminating surface of said lamp set.

11. The light distribution board having multiple light gratings each with many arciform (convex or concave) lenses as in claim 1, wherein: said at least one side is a top surface, said arciform lens light gratings are formed on said top surface of said transparent board and are a plurality of concentric annular light gratings and a plurality of concentric arc shaped light gratings in combination, said top surface is a light receiving surface of said lamp set, a bottom surface of said transparent board is a plane, bevel or arc shaped surface or is form thereon a plurality of granular convex lenses and is an illuminating surface of said lamp set.

12. The light distribution board having multiple light gratings each with many arciform (convex or concave) lenses as in claim 1, wherein: said at least one side is a top surface, said arciform lens light gratings are formed on said top surface of said transparent board and are a plurality of non-concentric arc shaped light gratings in combination, said top surface is a light receiving surface of said lamp set, a bottom surface of said transparent board is a plane, bevel or arc shaped surface or is form thereon a plurality of granular convex lenses and is an illuminating surface of said lamp set.

13. The light distribution board having multiple light gratings each with many arciform (convex or concave) lenses as in claim 1, wherein: said transparent board is in a rectangular, round, elliptical or strange shape.

14. The light distribution board having multiple light gratings each with many arciform (convex or concave) lenses as in claim 1, wherein: material for said transparent board is transparent plastics, transparent glass or some other transparent material.

15. The light distribution board having multiple light gratings each with many arciform (convex or concave) lenses as in claim 1, wherein: said light distribution board comprises two transparent boards of which one overlaps another, an upper one of which has a top surface formed thereon a plurality of arciform lens light gratings, said top surface is a light receiving surface of said lamp set, and a bottom surface which is in a plane, a bevel or an arc shape; and a lower one of which has a top surface formed thereon a plurality of arciform lens light gratings, said top surface is a light receiving surface of said lamp set, and a bottom surface which is in a plane, a bevel or an arc shape or is form thereon a plurality of granular convex lenses and is an illuminating surface of said lamp set.
